(19) United States
(12) Patent Application Publication
(10) Pub. No.: US 2015/0364151 A1
(43) Pub. Date: Dec. 17, 2015

(54) OPTICAL INFORMATION RECORDING AND REPRODUCING DEVICE, OPTICAL INFORMATION RECORDING AND REPRODUCING METHOD, AND REPRODUCING DEVICE

(71) Applicants: Toshiki ISHII, Tokyo (JP); Takeshi OGATA, Tokyo (JP)

(72) Inventors: Toshiki ISHII, Tokyo (JP); Takeshi OGATA, Tokyo (JP)

(21) Appl. No.: 14/395,873

(22) PCT Filed: Apr. 23, 2012
(86) PCT No.: PCT/JP2012/002768

§ 371 Date: Oct. 21, 2014

(51) Int. Cl. G11B 7/0065; G11B 7/1353; G11B 7/1395; G11B 7/007

(52) U.S. Cl. CPC G11B 7/0065; G11B 7/00772; G11B 7/1353; G11B 7/1395

(57) ABSTRACT

In recording and reproducing devices that use angular-multiplexing holography, accessing a recorded hologram of interest had taken time because after positioning at the vicinity of the hologram, it had been necessary to carry out fine adjustment of the position while checking the signal quality of the hologram. The optical information recording and reproducing device according to the present invention uses angular-multiplexing to record interference patterns formed from a signal beam and a reference beam onto an optical information recording medium as page data and reproduces information from the optical information recording medium, said optical information recording and reproducing unit being provided with: a light-source unit that outputs light; an optical splitting unit that splits the light into a reference beam and a signal beam; an angle controlling unit that controls the angle for the direction of angle multiplexing at which the reference beam enters the optical information recording medium; an optical detecting unit that detects a reproduced image that is reproduced by using the reference light; and a position control unit that controls the position relationship between the reference beam and the optical information recording medium. The device treats a set of page data as a book, and during recording, at least a portion of the page data in adjacent books is recorded while the entrance angle for the direction of angular-multiplexing for the reference light is shifted by means of the angle controlling unit. During reproduction, at least a portion of the light amount of a reproduced image is detected by using the optical detecting unit, and the position of the book is detected on the basis of information about the detected light amount.

### TECHNICAL FIELD

The present invention relates to a device and a method that record or reproduce information on or from an optical information recording medium by using holography.

### BACKGROUND ART

Through a Blu-ray Disc™ specification using a blue-violet semiconductor laser, at present, commercialization of optical disk having recording density of about 50 GB can be performed also in consumer use. From now on, large capacity that is the same as HDD (Hard Disk Drive) capacity of 100 GB to 1 TB is expected also in an optical disk.

However, for realizing the above-described ultra-high density by using an optical disk, a high-density technology is needed through a new method that is different from a high-density technology using a short wavelength and a high numerical aperture of objective lens.

Research about next-generation storage technology is performed, while a hologram recording technique in which digital information is recorded by using holography gathers attention.

The hologram recording technique is a technique in which signal light having information about page data modulated two-dimensionally by a spatial light modulator is overlapped with reference light in a recording medium and refractive index modulation is generated in the recording medium by interference fringe patterns generated at that moment to thereby record information on the recording medium.

During reproduction of information, when reference light used during recording is irradiated on the recording medium, a hologram recorded in the recording medium acts as diffraction grating and generates diffracted light. Signal light recorded by the diffracted light and phase information are included and reproduced as the same light.

The reproduced signal light is fast detected two-dimensionally by using an optical power detector such as a CMOS or a CCD. As described above, in the hologram recording technique, two-dimensional information can be straight recorded on an optical recording medium by one hologram, and further the above information can be reproduced. Further, a plurality of page data can be overwritten in a portion in which the recording medium is placed, and therefore large-capacity and fast information can be recorded or reproduced.

As the hologram recording technique, for example, JP-A-2004-272268 (Patent Literature 1) is disclosed. In this publication, a technique of multiplexing holograms for recording is disclosed.

### CITATION LIST

### Patent Literature

PATENT LITERATURE 1: JP-A-2004-272268

### SUMMARY OF INVENTION

### Technical Problem

Incidentally, there is a problem that in recording and reproducing devices that use angular-multiplexing holography, it takes time to access a recorded target hologram because after performing positioning at the vicinity of the target hologram, it is necessary to carry out a fine adjustment of a position while signal quality of the hologram is checked.

To solve the foregoing problem, a configuration according to claims is used as one example in the present invention.

### Advantageous Effects of Invention

According to the present invention, it is possible to fast access a recorded target hologram, and therefore a user-friendly optical information recording and reproducing device can be provided.

### BRIEF DESCRIPTION OF DRAWINGS

FIG. 1 is a schematic view illustrating a relationship between a reproduction light amount and a page recording angle in each book;

FIG. 2 is a schematic view illustrating an embodiment of an optical information recording and reproducing device;

FIG. 3 is a schematic view illustrating the embodiment of a pickup in the optical information recording and reproducing device;

FIG. 4 is a schematic view illustrating the embodiment of the pickup in the optical information recording and reproducing device;

FIG. 5 is a schematic view illustrating the embodiment of the pickup in the optical information recording and reproducing device;

FIG. 6 is a schematic view illustrating the embodiment of an operation flow of the optical information recording and reproducing device;

FIG. 7 is a schematic view illustrating the embodiment of a signal generation circuit of the optical information recording and reproducing device;

FIG. 8 is a schematic view illustrating the embodiment of a signal processing circuit of the optical information recording and reproducing device;

FIG. 9 is a schematic view illustrating the embodiment of an operation flow of the signal generation circuit and the signal processing circuit;

FIG. 10 is a schematic view illustrating the embodiment of a layered structure of an optical information recording medium having a reflective layer;

FIG. 11 is a view illustrating a method for arranging books on the optical information recording medium;

FIG. 12 is a view illustrating a flow for performing positioning at a target book position on the basis of information about the reproduction light amount;

FIG. 13 is a schematic view illustrating a relationship between the reproduction light amount and the page recording angle in each book;

FIG. 14 is a schematic view illustrating a relationship between the reproduction light amount and the page recording angle in each book;

FIG. 15 is a view illustrating a flow for performing positioning at the target book position on the basis of information about the reproduction light amount;

FIG. 16 is a schematic view illustrating the embodiment of the pickup in the optical information recording and reproducing device;

FIG. 17 is a view illustrating an angle multiplexed direction and a direction perpendicular to angular-multiplexing;

FIG. 18 is a view illustrating a relationship between a reproduced image and the presence or absence of an angle shift of reference light in a portion subjected to multiple recording;

FIG. 19 is a schematic view illustrating a relationship between the reproduction figure and the page recording angle in each book;

FIG. 20 is a view illustrating a flow for performing positioning at the target book position on the basis of information about the reproduction light amount;

FIG. 21 is a schematic view illustrating a method for detecting a bright portion and a dark portion of the reproduced image;

FIG. 22 is a view illustrating a flow for performing positioning at the target book position on the basis of information about the reproduction light amount; and

FIG. 23 is a schematic view illustrating a relationship between the reproduction light amount and the page recording angle in each book.

### DESCRIPTION OF EMBODIMENTS

Hereinafter, embodiments of the present invention will be described with reference to the accompanying drawings.

### First Embodiment

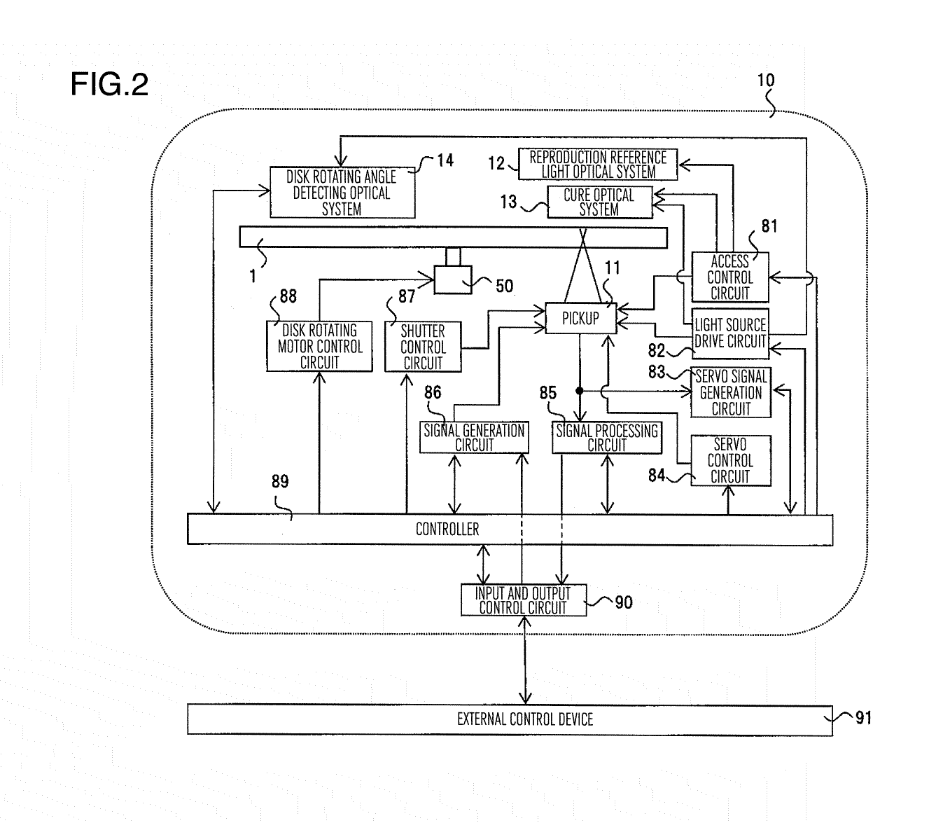

A first embodiment of the present invention will be described with reference to the accompanying drawings. FIG. 2 is a block diagram illustrating a recording and reproducing device including an optical information recording medium on and/or from which digital information is recorded and/or reproduced by using holography.

An optical information recording and reproducing device 10 is connected to an external control device 91 via an input and output control circuit 90. In the case of performing a recording operation, the optical information recording and reproducing device 10 receives an information signal to be recorded from the external control device 91 via the input and output control circuit 90. In the case of performing a reproducing operation, the optical information recording and reproducing device 10 transmits a reproduced information signal to the external control device 91 via the input and output control circuit 90.

The optical information recording and reproducing device 10 includes a pickup 11, a reproduction reference light optical system 12, a cure optical system 13, a disk rotating angle detecting optical system 14, and a rotating motor 50. The optical information recording medium 1 is configured so as to be rotated by the rotating motor 50.

The pickup 11 plays a role in emitting reference light and signal light to the optical information recording medium 1 and recording digital information on the recording medium by using holography. On this occasion, an information signal to be recorded is supplied to a spatial light modulator of the pickup 11 via a signal generation circuit 86 by a controller 89, and the signal light is modulated by the spatial light modulator.

When reproducing the information recorded on the optical information recording medium 1, a light wave that is made incident on the optical information recording medium in a direction opposite to that at the time of recording reference light emitted from the pickup 11 is generated by the reproduction reference light optical system 12. Reproduction light reproduced by reproduction reference light is detected by an optical power detector described later of the pickup 11 and a signal is reproduced by a signal processing circuit 85.

Opening and closing time in a shutter of the pickup 11 is controlled via a shutter control circuit 87 by the controller 89, and thereby irradiation time of the reference light and the signal light irradiated on the optical information recording medium 1 can be adjusted.

The cure optical system 13 plays a role in generating a light beam for use in a pre-cure process and a post-cure process of the optical information recording medium 1. When information is recorded on a desired position in the optical information recording medium 1, the pre-cure process is a former process in which a predetermined light beam is previously irradiated before the reference light and the signal light are irradiated on the desired position. The post-cure process is a subsequent process in which after information is recorded on a desired position in the optical information recording medium 1, a predetermined light beam is irradiated so as not to add a postscript on the desired position.

The disk rotating angle detecting optical system 14 is used to detect a rotating angle of the optical information recording medium 1. When the optical information recording medium 1 is adjusted to a predetermined rotating angle, a signal according to the rotating angle is detected by the disk rotating angle detecting optical system 14. By using the detected signal, the rotating angle of the optical information recording medium 1 can be controlled via a disk rotating motor control circuit 88 by the controller 89.

From a light source drive circuit 82, a predetermined light source drive current is supplied to light sources of the pickup 11, the cure optical system 13, and the disk rotating angle detecting optical system 14, thus enabling each light source to emit a light beam with a predetermined light amount.

Also, the pickup 11 and the disk cure optical system 13 each have a mechanism capable of sliding a position in a radius direction of the optical information recording medium 1 with position control undertaken by the access control circuit 81.

Incidentally, in a recording technology using an angle multiple principle of holography, an allowable margin to a shift of the reference light angle is inclined to become extremely small.

Accordingly, on the pickup 11, a mechanism in which a shift amount of the reference light angle is detected needs to be provided. Further, a servo mechanism for generating a signal for servo control in the servo signal generation circuit 83 and correcting the shift amount via a servo control circuit 84 needs to be provided on the optical information recording and reproducing device 10.

In the pickup 11, the cure optical system 13, and the disk rotating angle detecting optical system 14, several optical system configurations or all the optical system configurations may be integrated into one configuration for simplicity.

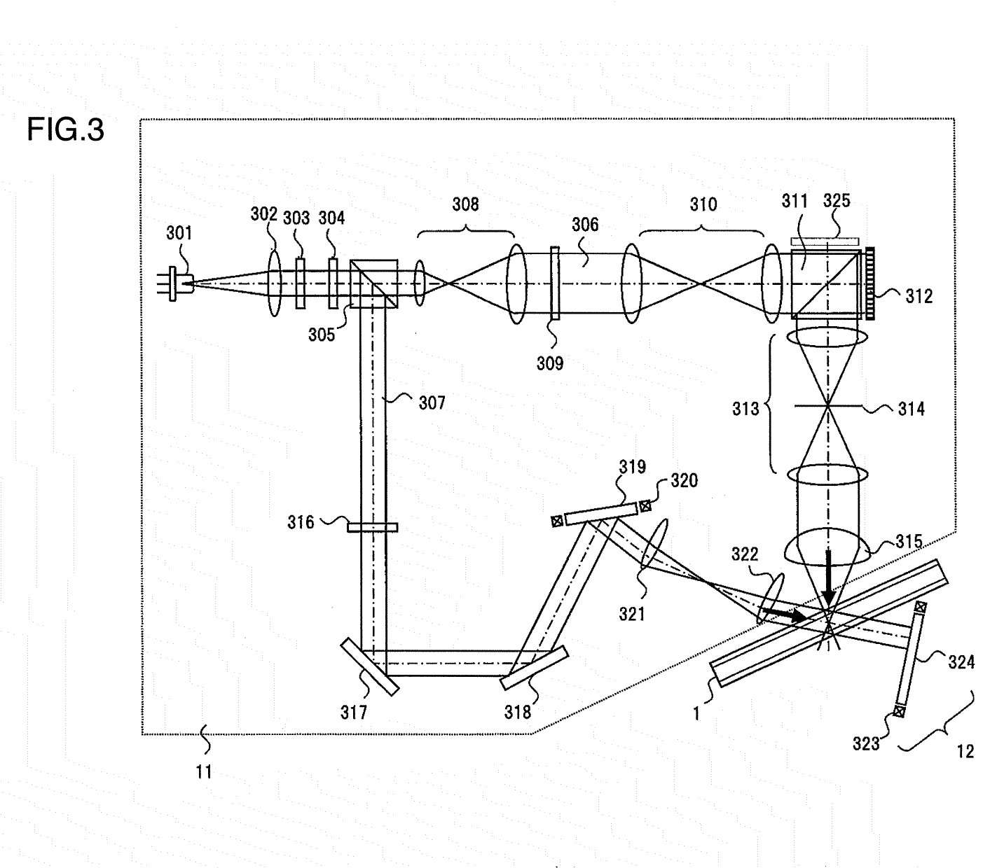

FIG. 3 illustrates a recording principle in one example of a fundamental optical system configuration in the pickup 11 of the optical information recording and reproducing device 10. A light beam emitted from a light source 301 is transmitted through a collimator lens 302 and is incident on a shutter 303. When the shutter 303 is open, the light beam is passed through the shutter 303. Thereafter, a polarization direction is controlled so that a light volume ratio of p-polarization and s-polarization is a desired ratio through an optical device 304 composed of, for example, a ½ wavelength plate, etc., and then the light beam is incident on a PBS (Polarization Light Splitter) prism 305.

The light beam transmitted through the PBS prism 305 serves as signal light 306, and is expanded in a light beam diameter by a beam expander 308. Then, the light beam is transmitted through a phase mask 309, a relay lens 310, and a PBS prism 311, and is incident on a spatial light modulator 312.

The signal light to which information is added by the spatial light modulator 312 is reflected by the PBS prism 311 and propagated through a relay lens 313 and a spatial filter 314. Thereafter, the signal light is collected at the optical information recording medium 1 by an objective lens 315.

On the other hand, the light beam reflected by the PBS prism 305 serves as reference light 307, and is set to a predetermined polarization direction depending on whether for recording or for reproduction by a polarization direction conversion element 316. Then, the light beam is incident on a galvanometer mirror 319 via a mirror 317 and a mirror 318. Since an angle of the galvanometer mirror 319 is adjustable by an actuator 320, an incident angle of the reference light that is incident on the optical information recording medium 1 after transmitted through a lens 321 and a lens 322 can be set to a desired angle. For setting an incident angle of the reference light, a device that changes a wave surface of the reference light may be used in place of the galvanometer mirror.

As described above, on the optical information recording medium 1, the signal light and the reference light are made incident so as to overlap each other. Thereby, an interference fringe pattern is formed in the recording medium, and the pattern is written in the recording medium, thus recording information. In addition, since an incident angle of the reference light that is incident on the optical information recording medium 1 can be changed by the galvanometer mirror 319, recording using angular-multiplexing can be made.

Subsequently, in a hologram in which a reference light angle is changed and recording is made on the same area, the hologram according to the reference light angle is called a page one by one, and a set of angle-multiplexed pages in the same area is called a book.

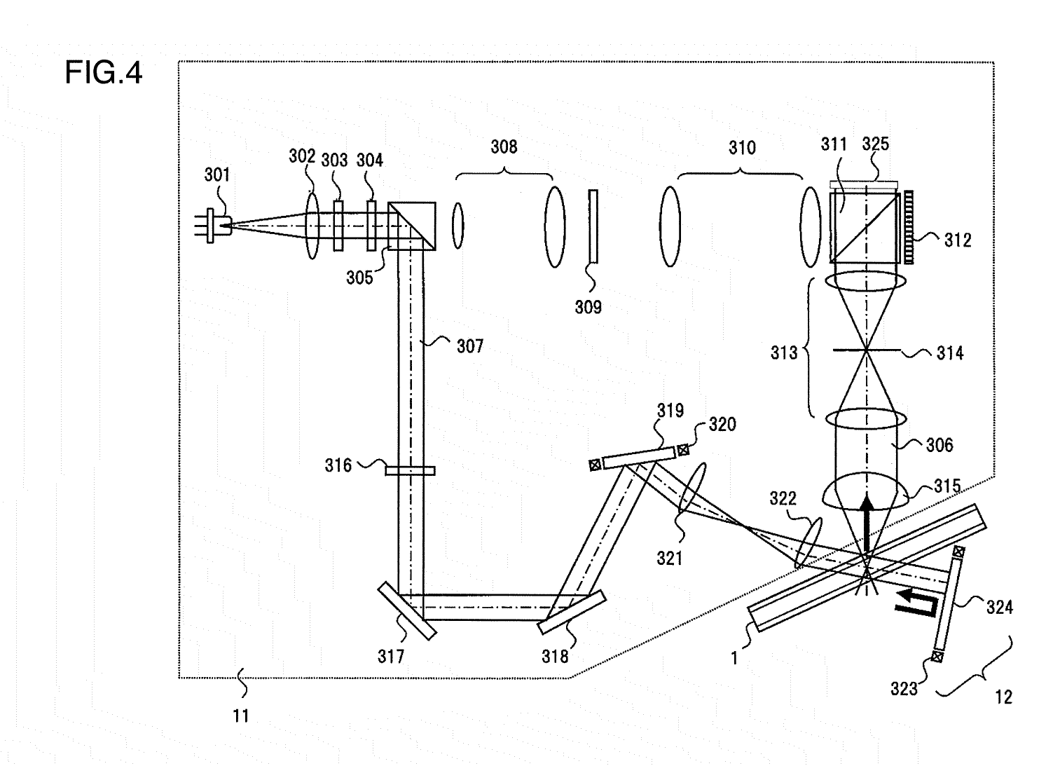

FIG. 4 illustrates a reproduction principle in one example of a fundamental optical system configuration in the pickup 11 of the optical information recording and reproducing device 10. When the recorded information is reproduced, the reference light is made incident on the optical information recording medium 1 as described above. The light beam transmitted through the optical information recording medium 1 is reflected through an actuator 323 by an angle-adjustable galvanometer mirror 324, thereby generating reproduction reference light thereof.

Reproduction light reproduced by the reproduction reference light is propagated through the objective lens 315, the relay lens 313, and the spatial filter 314. Thereafter, the reproduction light is transmitted through the PBS prism 311 and is incident on an optical power detector 325, thereby reproducing recorded signals. As the optical power detector 325, for example, an image pickup device such as a CMOS image sensor or a CCD image sensor can be used. Further, when page data can be reproduced, any device may be used.

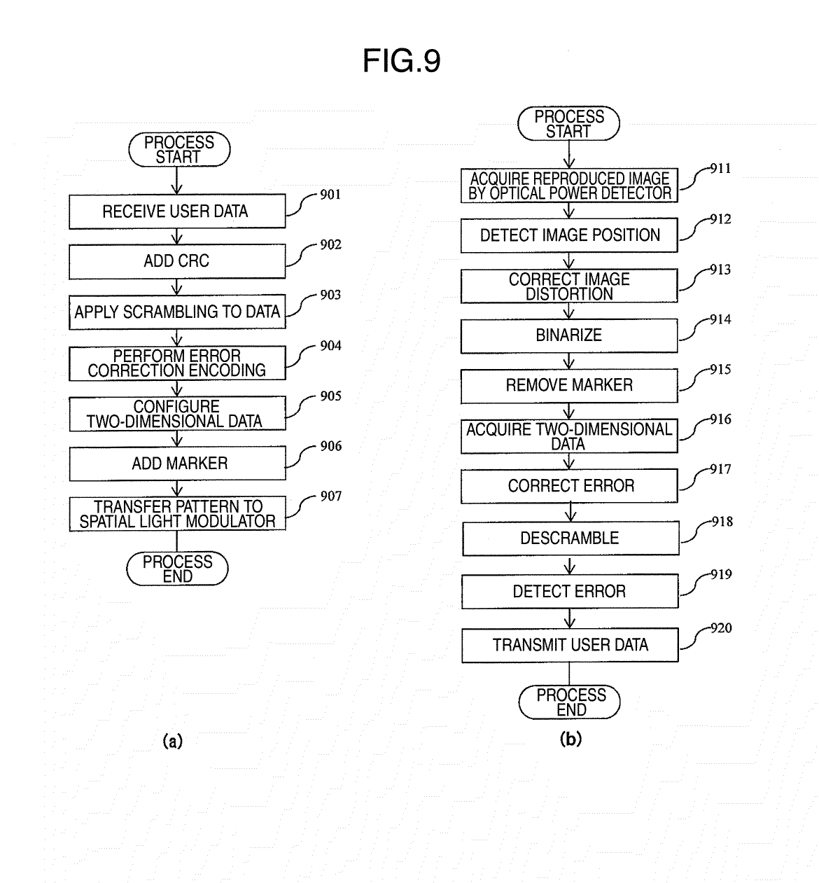

FIG. 9 illustrates a data processing flow during recording and reproduction. FIG. 9A illustrates a recording data processing flow at the signal generation circuit 86 from recording data reception 611 up to a conversion to two-dimensional data on the spatial light modulator 312 in the input and output control circuit 90. FIG. 9B illustrates a reproduction data processing flow at the signal processing circuit 85 from detecting the two-dimensional data by the optical power detector 325 up to reproduction data transmission 624 in the input and output control circuit 90.

Data processing during recording will be described with reference to FIG. 9A. When user data is received (901), a CRC is added to each data row (902) so as to be divided into a plurality of data rows and perform an error detection during reproduction. A scrambling is applied (903) that in order that the number of ON pixels and the number of OFF pixels may be appropriately equal to each other and repetition of the same pattern may be prevented, a pseudorandom number data row is added to the data row. Then, error correction encoding such as a Reed Solomon Code is performed (904) so as to perform an error correction during reproduction. Next, this data row is converted into two-dimensional data of M×N and the above conversion is repeated as much as data of one page, thereby configuring two-dimensional data as much as one page (905). A marker being a reference at an image position detection and image distortion correction during reproduction is added to the above-described configured two-dimensional data (906), and the data is transferred to the spatial light modulator 312 (907).

Next, a data processing flow during reproduction will be described with reference to FIG. 9B. Image data detected by the optical power detector 325 is transferred to the signal processing circuit 85 (911). An image position is detected (912) by using as a reference a marker included in this image data, and a distortion correction of a tilt, a multiplication constant, distortion, etc. of the image is performed (913). Then, binarization processing is performed (914) and the marker is removed (915), thereby acquiring the two-dimensional data of one page (916). The two-dimensional data acquired as described above is converted into a plurality of data rows, and then error correction processing is performed (917) and a parity data row is removed. Next, descrambling processing is applied (918) and error detection processing through the CRC is performed (919). A CRC parity is removed, and then the user data is transmitted via the input and output control circuit 90 (920).

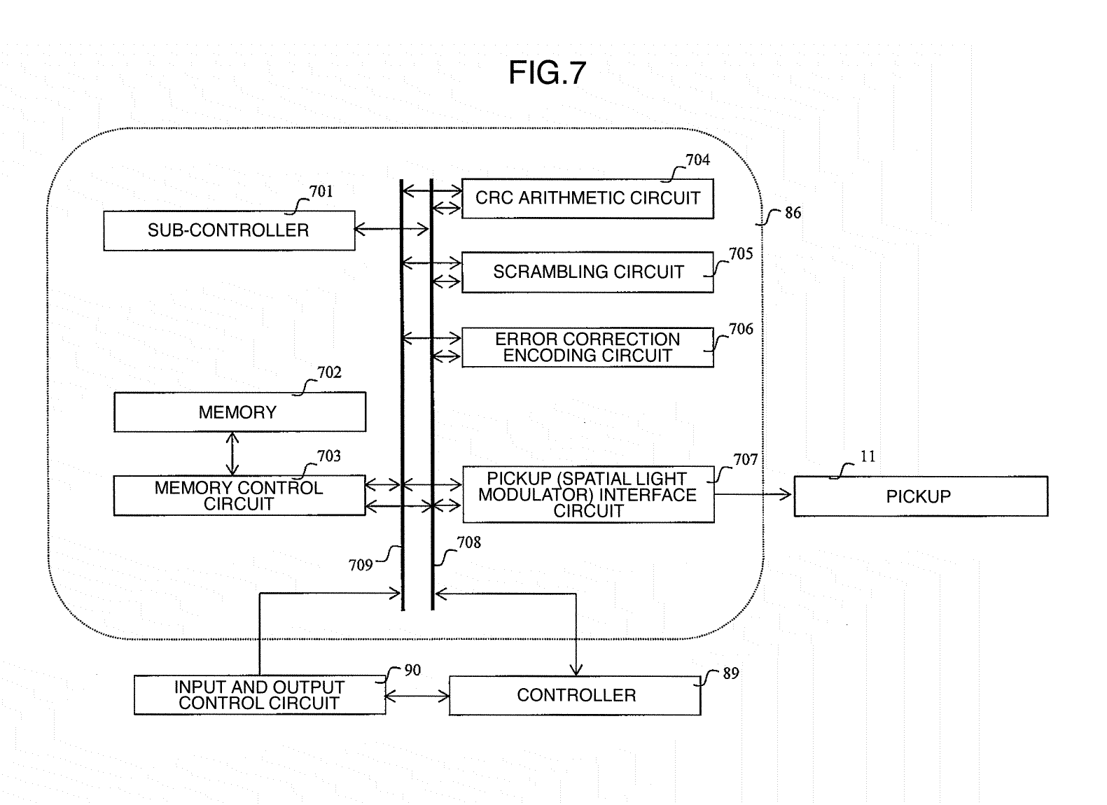

FIG. 7 is a block diagram illustrating the signal generation circuit 86 of the optical information recording and reproducing device 10.

When an input of the user data to the input and output control circuit 90 is started, the input and output control circuit 90 notifies the controller 89 that an input of the user data is started. When the notification is received, the controller 89 commands the signal generation circuit 86 to record data as much as one page input from the input and output control circuit 90. A processing instruction from the controller 89 is notified to a sub-controller 701 of the signal generation circuit 86 through a control line 708. When the notification is received, the sub-controller 701 controls each signal processing circuit through the control line 708 to operate each signal processing circuit in parallel. First, a memory control circuit 703 is controlled to store in a memory 702 the user data input from the input and output control circuit 90 through a data line 709. When the user data stored in the memory 702 reaches a certain fixed amount, a CRC arithmetic circuit 704 is controlled to add the CRC to the user data. Next, a scrambling circuit 705 is controlled to apply scrambling for adding a pseudorandom number data row to the data to which the CRC is added, and an error correction encoding circuit 706 is controlled to perform error correction encoding for adding a parity data row. Finally, a pickup interface circuit 707 is controlled to read out an error correction encoded data from the memory 702 in the order of arranging the two-dimensional data on the spatial light modulator 312. Further, the pickup interface circuit 707 is controlled to add a marker as a reference during reproduction to the two-dimensional data and then transfer the two-dimensional data to the spatial light modulator 312 of the pickup 11.

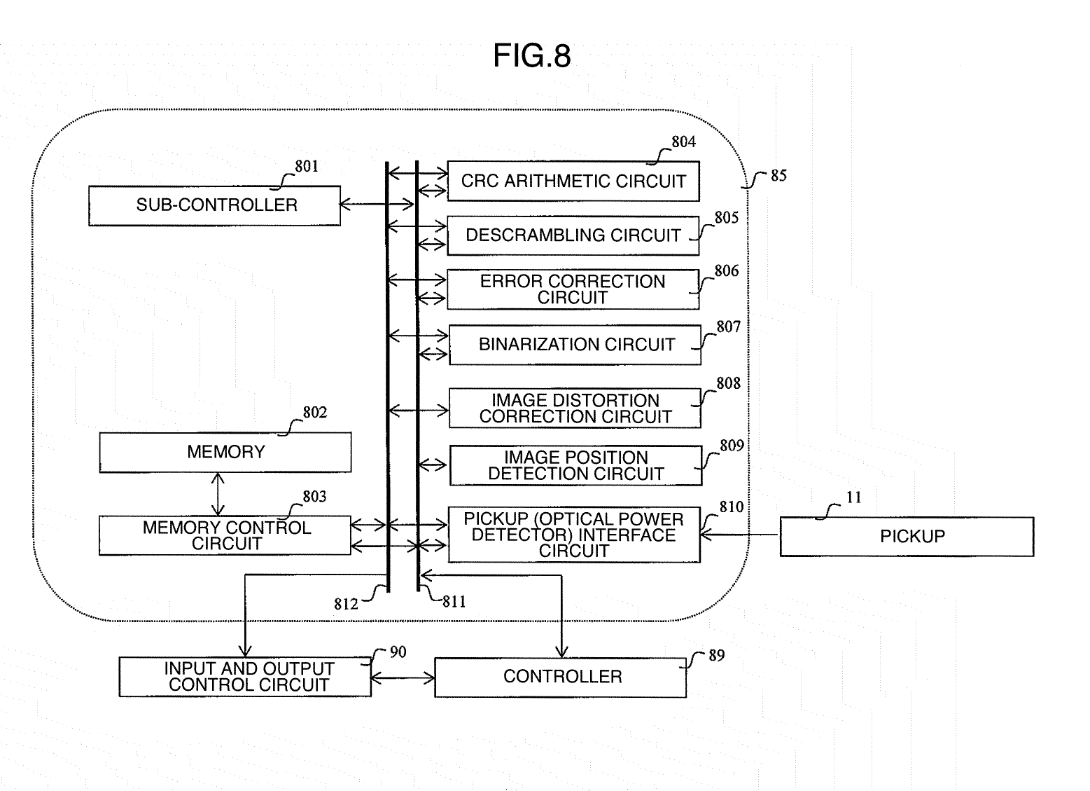

FIG. 8 is a block diagram illustrating the signal processing circuit 85 of the optical information recording and reproducing device 10.

When the optical power detector 325 of the pickup 11 detects image data, the controller 89 commands the signal processing circuit 85 to reproduce data as much as one page input from the pickup 11. A processing instruction from the controller 89 is notified to a sub-controller 801 of the signal processing circuit 85 through a control line 811. When the notification is received, the sub-controller 801 controls each signal processing circuit through the control line 811 to operate each signal processing circuit in parallel. First, a memory control circuit 803 is controlled through a data line 812 to store in a memory 802 image data input from the pickup 11 via a pickup interface circuit 810. When the data stored in the memory 802 reaches a certain fixed amount, an image position detection circuit 809 is controlled to detect a marker from the image data stored in the memory 802 and extract an effective data range. Next, by using the detected marker, an image distortion correction circuit 808 is controlled to perform a distortion correction of a tilt, a multiplication constant, distortion, etc. of the image and convert the image data to an expected size of the two-dimensional data. Each bit data of plural bits configuring the two-dimensional data a size of which is converted is binarized to determine “0” or “1” in a binarization circuit 807. Further, the memory control circuit 803 is controlled to store data in the memory 802 in the order of the output of reproduction data. Next, an error correction circuit 806 is controlled to correct an error included in each data row, and a descrambling circuit 805 is controlled to release scrambling for adding the pseudorandom number data row. Then, a CRC arithmetic circuit 804 is controlled to perform checking so as not to include an error in the user data in the memory 802. Thereafter, the user data is transferred from the memory 802 to the input and output control circuit 90.

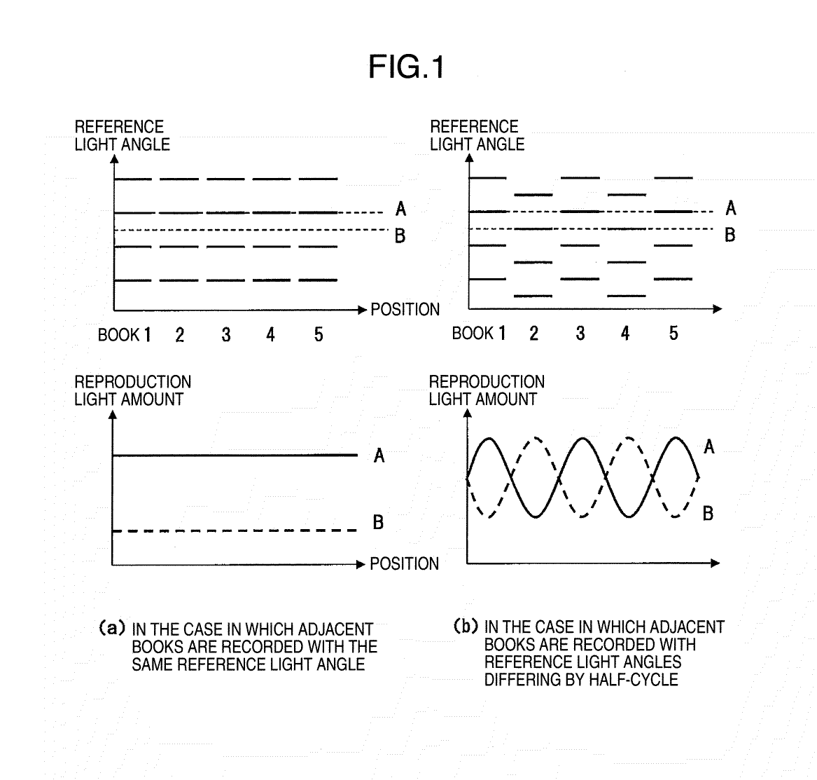

FIG. 1 is a view schematically illustrating a reference light recording angle in each book and a reproduction light amount in each book position during reproduction.

FIG. 1A is an example in the case in which adjacent books are recorded with the same reference light angle in each page. An upper view of FIG. 1A is a view illustrating a relationship between a position of the book and a reference light angle with which the pages are recorded, and illustrates that the adjacent books are recorded with the same reference light angle in each page. Here, on a Fourier plane of the optical information recording medium 1, a size of the hologram is regulated by the spatial filter 314. Further, the adjacent books are supposed to be bedded at a distance of approximately a size of this hologram and be recorded. Suppose that as illustrated in A of the upper view of FIG. 1A, the reference light angle during reproduction is matched to an angle with which the pages are recorded. In this case, as illustrated in A of a lower view of FIG. 1A, the reproduction light amount is detected at almost a certain level. Suppose that as illustrated in B of the upper view of FIG. 1A, the reference light angle during reproduction is in the middle of the angles with which the pages are recorded. Also in this case, as illustrated in B of the lower view of FIG. 1A, the reproduction light amount is detected at almost a certain level. Accordingly, in the case of recording as illustrated in FIG. 1A, since the reproduction light amount is always constant, it is difficult to detect a position of the book on the basis of information about the reproduction light amount.

FIG. 1B is an example in the case in which the adjacent books are recorded with different reference light angles in each page, and particularly illustrates a case in which the adjacent books are recorded with the reference light angles that are different by a half cycle in each page. An upper view of FIG. 1B is a view illustrating a relationship between positions of the books and reference light angles with which the pages are recorded, and illustrates that the adjacent books are recorded with the reference light angles that are different by a half cycle in each page. Suppose that as illustrated in A of the upper view of FIG. 1B, the reference light angle during reproduction is matched to an angle with which the pages of the books indicated by odd numbers are recorded. In this case, as illustrated in A of a lower view of FIG. 1B, in the reproduction light amount, a peak is shown in the middle of the books indicated by the odd numbers. The reason is that the light amount is obtained in the book indicated by the odd number and the light amount is not obtained in the book indicated by an even number. Suppose that as illustrated in B of the upper view of FIG. 1B, the reference light angle during reproduction is matched to an angle with which the pages of the books indicated by the even numbers are recorded. In this case, as illustrated in B of the lower view of FIG. 1B, in the reproduction light amount, a peak is shown in the middle of the books indicated by the even numbers. Accordingly, in the case of recording as illustrated in FIG. 1B, since a peak of the reproduction light amount is obtained every two books, it is possible to detect a position of the book on the basis of information about the reproduction light amount.

There is described a case in which the reference light angle during reproduction is matched to an angle with which the pages of the books indicated by the odd numbers or the even numbers are recorded. The reason is that amplitude of the reproduction light amount is largely taken, and when the amplitude of the reproduction light amount is obtained even if the reference light angle is not necessarily matched to an angle with which the pages are recorded, it is possible to detect a position of the book on the basis of information about the reproduction light amount.

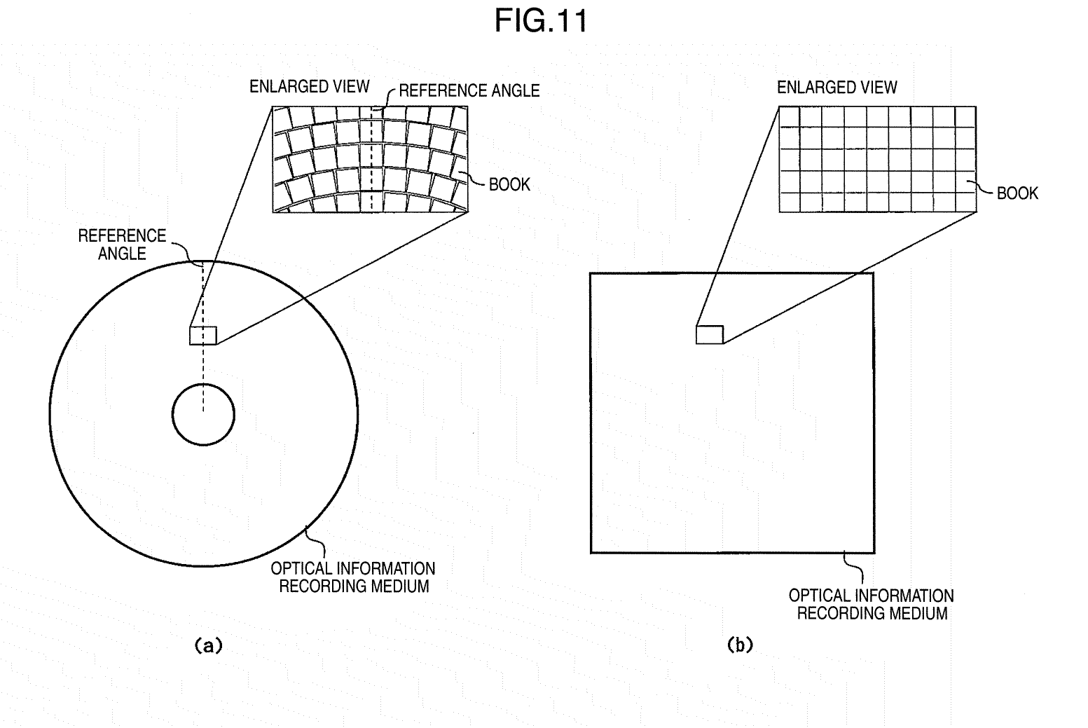

FIG. 11 is a view illustrating an example of a method for arranging the books in the optical information recording medium. FIG. 11A is an example of a circular optical information recording medium. An enlarged view of FIG. 11A illustrates an arrangement example of the books on the Fourier plane of the optical information recording medium. When the books are supposed to be arranged concentrically, a shift is generated in a position of the book by a change in a radius position. To cope with the above, suppose that a predetermined angle of the optical information recording medium is set as a reference angle and the books are arranged so that a center of the book is necessarily matched to the reference angle. FIG. 11B is an example of a rectangular optical information recording medium. An enlarged view of FIG. 11B illustrates an arrangement example of the books on the Fourier plane of the optical information recording medium. In this case, since a shift is not generated in a position of the book, the books can be arranged in a lattice shape. Subsequently, on the premise of an example of the circular optical information recording medium of FIG. 11A, descriptions will be made.

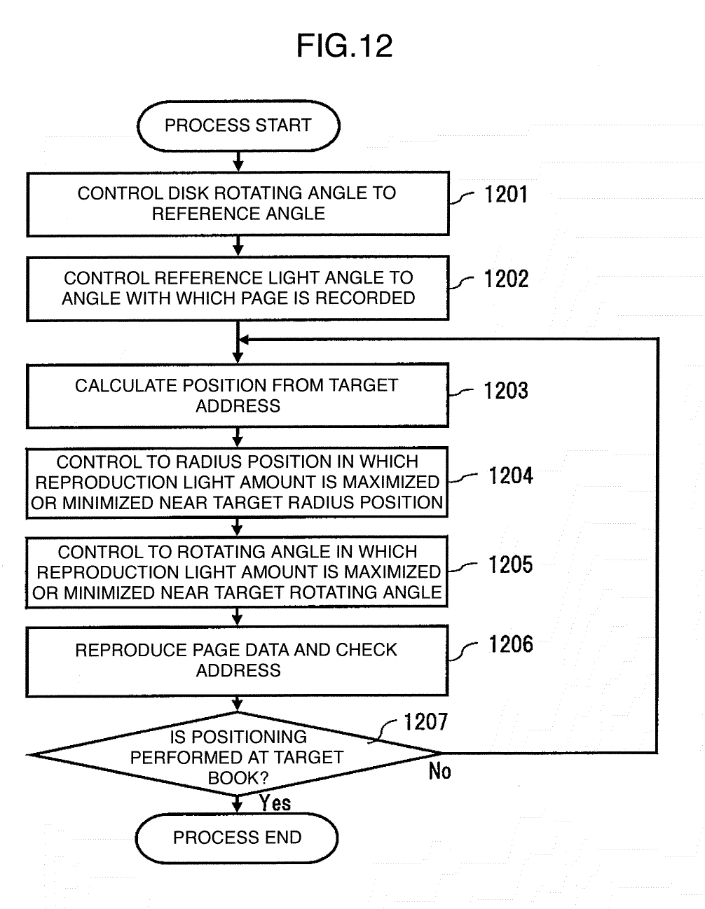

FIG. 12 is a view illustrating a flow for performing positioning at the target book.

First, the disk rotating motor control circuit 88 is controlled to drive the rotating motor 50, and is controlled to match a rotating angle of the optical information recording medium 1 to the reference angle (1201). Further, the disk rotating motor control circuit 88 is controlled to match the reference light angle to an angle with which any books of the odd-numbered books and the even-numbered books in FIG. 1 are recorded in each page (1202).

Next, the radius position and the rotating angle of the optical information recording medium of the target book are calculated from address information as a target (1203). On the basis of information about the calculated radius position, the access control circuit 81 is controlled to drive the pickup 11 to the radius direction of the optical information recording medium 1, and at the same time, is controlled to continuously detect the reproduction light amount by the optical power detector 325 while the reference light is irradiated on the optical information recording medium 1 (1204). As described above, a peak of the reproduction light amount is obtained every two books, and therefore the vicinity of the target radius position may be accessed while the number of the peaks is counted, or the vicinity of the target radius position may be accessed on the basis of information about a linear encoder for detecting a position of the radius direction. After the vicinity of the target radius position is accessed, in the case in which the reproduction light amount is calculated to be maximized in the relevant book, the radius position is controlled so that the reproduction light amount is maximized, or in the case in which the reproduction light amount is calculated to be minimized in the relevant book, the radius position is controlled so that the reproduction light amount is minimized.

Next, on the basis of information about the rotating angle calculated at 1203, the disk rotating motor control circuit 88 is controlled to drive the rotating motor 50, and at the same time, is controlled to continuously detect the reproduction light amount by the optical power detector 325 while the reference light is irradiated on the optical information recording medium 1 (1205). In the same manner as in the above-described control of the radius position, a peak of the reproduction light amount is obtained every two books, and therefore the vicinity of the target rotating angle may be accessed while the number of the peaks is counted, or the vicinity of the target rotating angle may be accessed on the basis of information about the linear encoder for detecting the rotating angle. After the vicinity of the target rotating angle is accessed, in the case in which the reproduction light amount is calculated to be maximized in the relevant book, the rotating angle is controlled so that the reproduction light amount is maximized, or in the case in which the reproduction light amount is calculated to be minimized in the relevant book, the rotating angle is controlled so that the reproduction light amount is minimized.

Next, the page data is reproduced and the address is checked from header information and the like (1206). When positioning at the target book can be checked from the address information, access to the book is ended. When the positioning at the target book cannot be checked, the process returns to 1203 again and the positioning at the book is performed.

In the case in which signal quality of the page is deteriorated when the page data is reproduced at 1206, a fine adjustment of the book position may be carried out so that the signal quality becomes high.

On the premise that the optical information recording medium 1 is circular and a record is made concentrically, descriptions are made; however, the present invention is not limited thereto. The record may be made in a spiral manner and the optical information recording medium may be, for example, rectangular. Even in any case, scanning appropriate to a shape and a book arrangement of the optical information recording medium is performed, and thereby the positioning at the books can be performed.

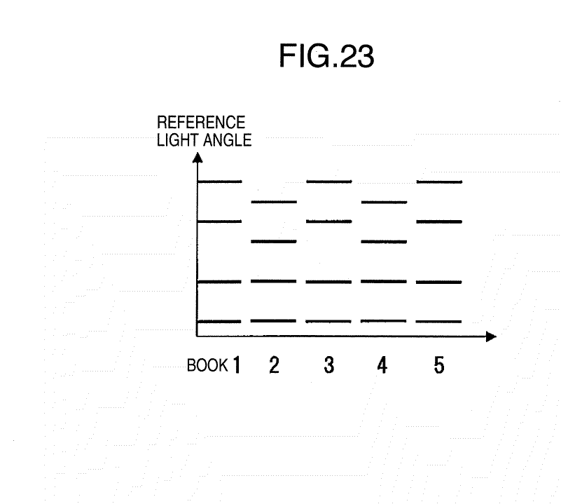

In addition, in the case in which the reference light angle is shifted in the adjacent books, an angle may be shifted in all the pages of the book, or an angle may be shifted in a part of the pages. As illustrated in FIG. 23, for example, the books may be recorded with an angle of the page being shifted at a predetermined angle in the book, and the books may be recorded with an angle of the page being aligned other than the predetermined angle in the book. In this case, when the angle of the page is set to the reference light angle with which an angle of the page is shifted and the record is made, the positioning at the book can be performed. In a portion in which an angle of the page is aligned and the record is made, a shift amount of an angle of the page is set to a cycle different from a half cycle, and thereby another function can be made to be held.

In addition, as the reproduction light amount for detecting a position of the book, the light amount of all the pages may be used, or the light amount of a part of the pages may be used.

For the purpose of detecting the reproduction light amount for detecting a position of the book, an example of using the optical power detector 325 is described. Further, an optical device for splitting the reproduction light, a lens for collecting the reproduction light, and the optical power detector may be separately provided to detect the reproduction light amount. Fast detection can be performed by using as the optical power detector a photodetector or the like.

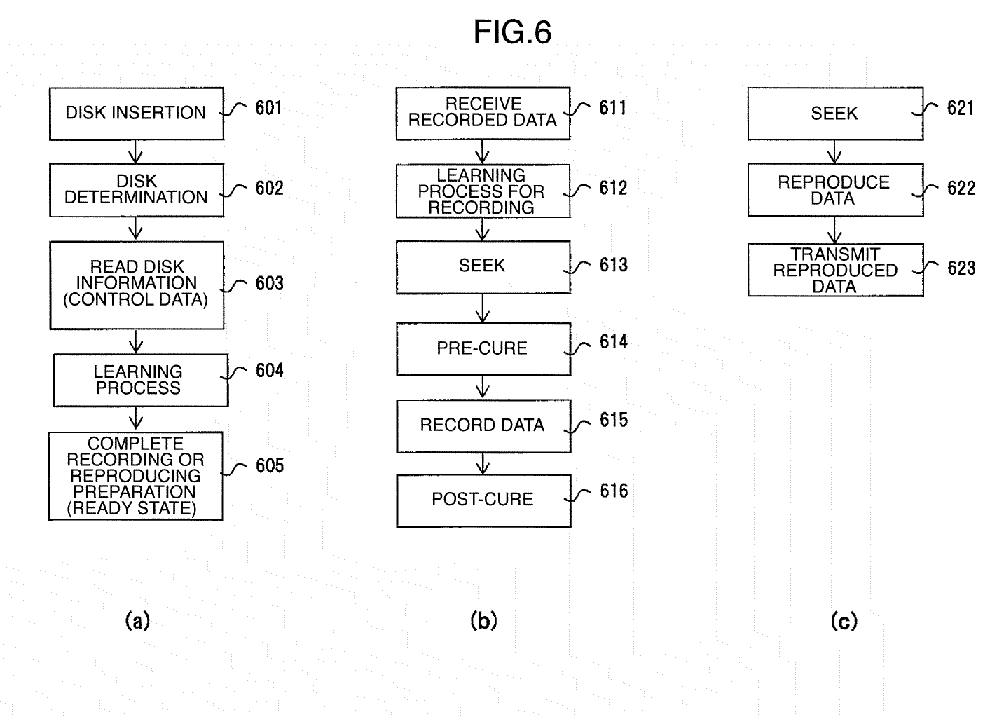

FIG. 6 illustrates an operation flow of recording and reproduction in the optical information recording and reproducing device 10. Here, a flow with regard to the recording and the reproduction using holography will be particularly described.

FIG. 6A illustrates an operation flow until preparations of the recording or the reproduction are completed after the optical information recording medium 1 is inserted into the optical information recording and reproducing device 10. FIG. 6B illustrates an operation flow until information is recorded on the optical information recording medium 1 after a state in which the preparations are completed. FIG. 6C illustrates an operation flow until the information recorded on the optical information recording medium 1 is reproduced after the state in which the preparations are completed.

When the medium is inserted as illustrated in FIG. 6A (601), the optical information recording and reproducing device 10 performs disk determination whether the inserted medium is, for example, a medium on or from which digital information is recorded or reproduced by using holography (602).

As a result of the disk determination, when the inserted medium is an optical information recording medium on or from which digital information is recorded or reproduced by using holography is determined, the optical information recording and reproducing device 10 reads out control data provided on the optical information recording medium (603). Further, the optical information recording and reproducing device 10 acquires, for example, information about the optical information recording medium and, for example, information about various types of setting conditions during recording or reproduction.

After the readout of the control data, the optical information recording and reproducing device 10 performs various types of adjustments according to the control data and a learning process (604) with regard to the pickup 11, and completes the preparations of recording or reproduction (605).

In the operation flow until the information is recorded after the state in which the preparations are completed, as illustrated in FIG. 6B, data to be recorded is first received (611) and information according to the data is transmitted to the spatial light modulator 312 of the pickup 11.

Thereafter, the optical information recording and reproducing device 10 previously performs various types of learning processes for recording of, for example, power optimization of the light source 301, optimization of exposure time through the shutter 303, or the like, if necessary, so as to record high-quality information on the optical information recording medium (612).

Thereafter, in a seek operation (613), the access control circuit 81 is controlled, and positions of the pickup 11 and the cure optical system 13 are positioned in a predetermined position of the optical information recording medium. Here, the positioning at the target book can be performed by the above-described method.

Thereafter, the optical information recording and reproducing device 10 pre-cures a predetermined area by using a light beam emitted from the cure optical system 13 (614), and records data by using the reference light and the signal light emitted from the pickup 11 (615). Here, during recording, the adjacent books are recorded with the angles that are different by a half cycle in each page.

After the data is recorded, the optical information recording and reproducing device 10 performs post-cure by using the light beam emitted from the cure optical system 13 (616). The data may be verified, if necessary.

In an operational flow until the recorded information is reproduced after the state in which the preparations are completed, as illustrated in FIG. 6C, the access control circuit 81 is first controlled through the seek operation (621). Positions of the pickup 11 and the reproduction reference light optical system 12 are positioned in a predetermined position of the optical information recording medium. Here, the positioning at the target book can be performed by the above-described method.

Thereafter, the reference light is emitted from the pickup 11 and the information recorded on the optical information recording medium is read out (622) to thereby transmit the reproduced data (623).

There is a problem that conventionally, in the optical information recording and reproducing devices that use angular-multiplexing holography, in the case of reproducing information from the optical information recording medium, for performing positioning at a predetermined book of the optical information recording medium, approximate positioning is performed and then a fine adjustment of the book position is required to be carried out while the signal quality is determined, and it takes time to complete the positioning. In particular, in the case in which an eccentricity caused by a shift of chucking, etc. is large when the optical information recording medium is attached to the optical information recording and reproducing device, or in the case in which a recording position of the book is not appropriate by a problem of compatibility between devices, a shift from a central position of the book is large in a stage where approximate positioning is performed and it takes time to carry out a fine adjustment. However, according to the first embodiment as described above, the positioning at the book can be fast performed by using the reproduction light amount, and therefore a user-friendly optical information recording and reproducing device can be provided.

### Second Embodiment

A second embodiment of the present invention will be described with reference to the accompanying drawings. Configurations of an optical information recording and reproducing device and a pickup are the same as those of the first embodiment, and therefore descriptions will be omitted.

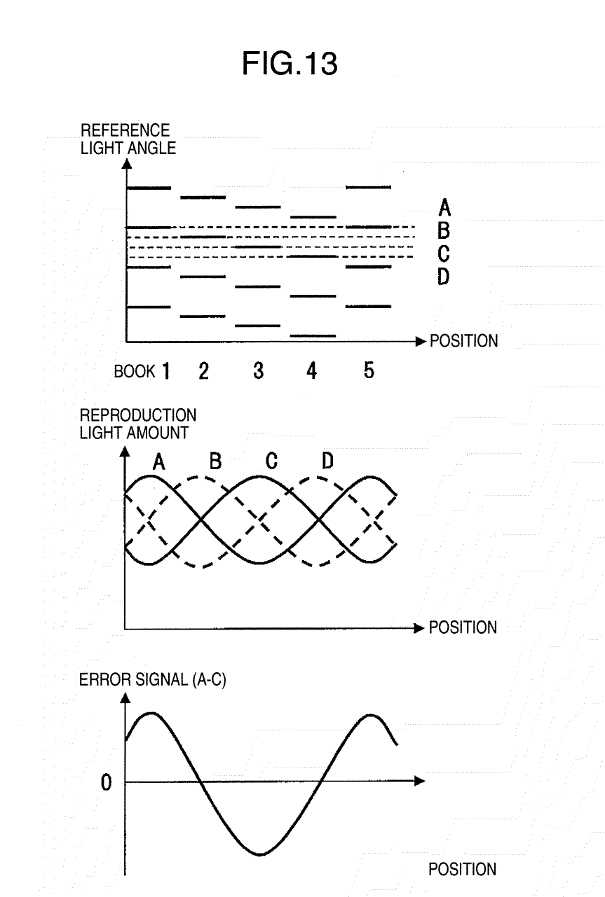

FIG. 13 is an example in the case in which adjacent books are recorded with reference light angles that are different by a quarter cycle in each page. An upper view of FIG. 13 is a view illustrating a relationship between positions of the books and the reference light angles with which the pages are recorded, and illustrates that the adjacent books are recorded with the reference light angles that are different by a quarter cycle in each page. In the case in which the reference light angles during reproduction are angles with which the pages of a first book and a fifth book are recorded as illustrated in A in the upper view of FIG. 13, in the reproduction light amount, a peak is shown in the center of the book every four books as illustrated in A in the middle view of FIG. 13. The reason is that the reference light angle is matched to a recording angle of the page every four books and the reproduction light amount is maximized. In a similar way, in the case in which the reference light angles during reproduction are angles with which the pages of a second book, a third book, and a fourth book are recorded as illustrated in B, C, and D in the upper view of FIG. 13, the reproduction light amount is maximized in the center of each of the book positions and a peak is shown in the center of the book every four books. Here, for example, when a signal obtained by subtracting the reproduction light amount C from the reproduction light amount A is generated, an error signal that a signal level is equal to zero in the center of the second book and the fourth book can be generated as illustrated in the lower view of FIG. 13. Accordingly, feedback control is performed on the basis of the generated error signal, and thereby positioning at the book can be performed.

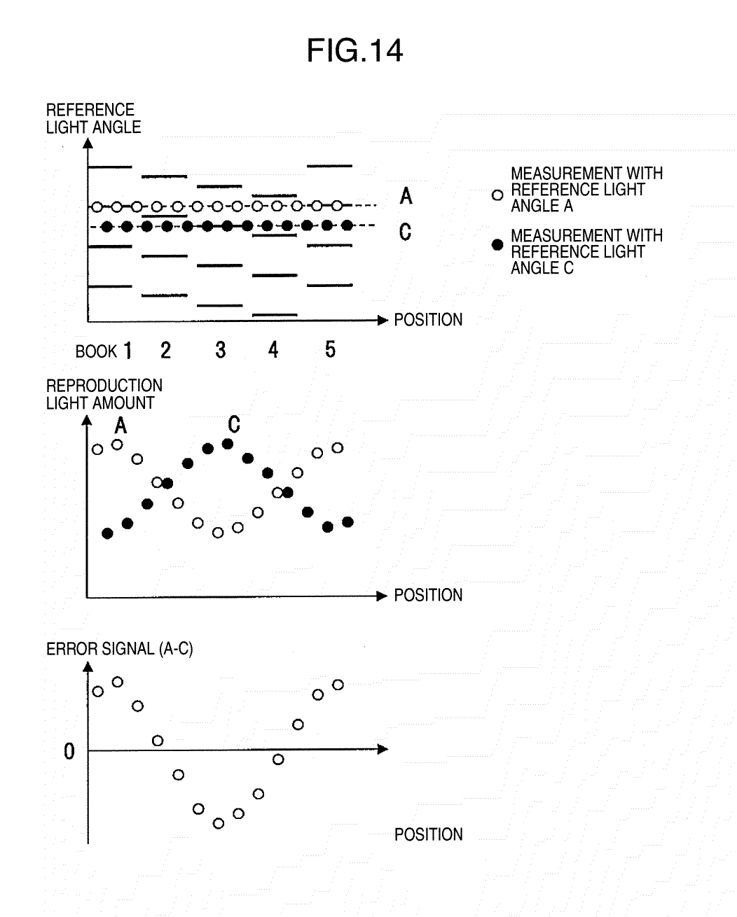

FIG. 14 is a view illustrating a method for obtaining the reproduction light amount with two reference light angles. In the present embodiment, information about the two reference light angles is required. Therefore, as illustrated in an upper view of FIG. 14, for example, the reference light angle is alternately switched between the reference light angle A and the reference light angle C, and the reproduction light amount is measured. At that moment, discrete reproduction light amounts A and C are obtained as illustrated in a middle view of FIG. 14. A previous measuring point is used in order to generate an error signal, and therefore a shift from the reproduction light amount at the present position is generated. However, the reference light angle is sufficiently fast switched and measured with respect to a movement of the book position, and thereby the above shift can be made small.

As an example of generating the error signal, a method for subtracting the reproduction light amount C from the reproduction light amount A is used, and descriptions are made. Further, in any case of a case of subtracting the reproduction light amount A from the reproduction light amount C, a case of subtracting the reproduction light amount D from the reproduction light amount B, and a case of subtracting the reproduction light amount B from the reproduction light amount D, the error signal can be generated and positioning at the book can be performed.

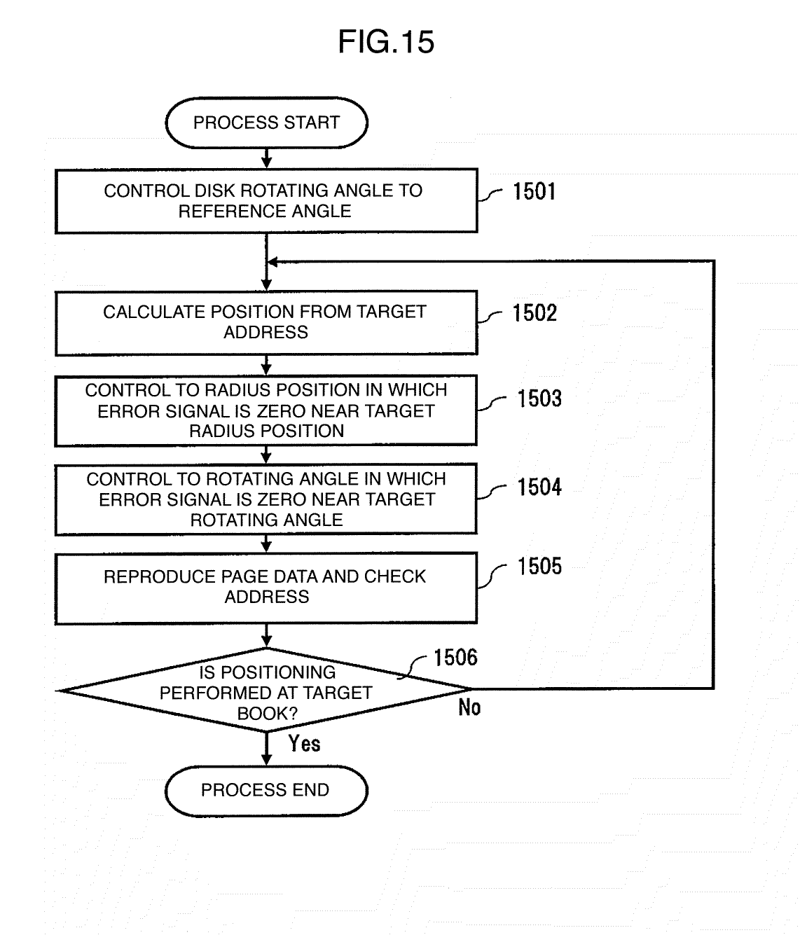

FIG. 15 is a view illustrating a flow for performing positioning at the target book.

First, the disk rotating motor control circuit 88 is controlled to drive the rotating motor 50, and is controlled to match a rotating angle of the optical information recording medium 1 to the reference angle (1501).

Next, the radius position and the rotating angle of the optical information recording medium of the target book are calculated from address information as a target (1502). On the basis of information about the calculated radius position, the access control circuit 81 is controlled to drive the pickup 11 to a radius direction of the optical information recording medium 1, and at the same time, is controlled to irradiate the reference light on the optical information recording medium 1 while the reference light angle is alternately switched between the two reference light angles as illustrated in FIG. 14, and detect the reproduction light amount by the optical power detector 325 (1503). At this time, two angles that the error signal is equal to zero in the target radius position may be previously calculated and selected as the two reference light angles. After the vicinity of the target radius position is accessed, the radius position is controlled so that the error signal is equal to zero in the relevant book.

Next, on the basis of information about the rotating angle calculated at 1502, the disk rotating motor control circuit 88 is controlled to drive the rotating motor 50, and at the same time, is controlled to irradiate the reference light on the optical information recording medium 1 while the reference light angle is alternately switched between the two reference light angles as illustrated in FIG. 14, and detect the reproduction light amount by the optical power detector 325 (1504). At this time, two angles that the error signal is equal to zero with the target rotating angle may be previously calculated and selected as the two reference light angles. After the vicinity of the target rotating angle is accessed, the rotating angle is controlled so that the error signal is equal to zero.

Next, the page data is reproduced and the address is checked from header information and the like (1505). When positioning at the target book can be checked from the address information, access to the book is ended. When the positioning at the target book cannot be checked, the process returns to 1502 again and the positioning at the book is performed.

In the case in which signal quality of the page is deteriorated when the page data is reproduced at 1505, a fine adjustment of the book position may be carried out so that the signal quality becomes high.

On the premise that the optical information recording medium 1 is circular and a record is made concentrically, descriptions are made; however, the present invention is not limited thereto. The record may be made in a spiral manner and the optical information recording medium may be, for example, rectangular. Even in any case, scanning appropriate to a shape and a book arrangement of the optical information recording medium is performed, and thereby the positioning at the books can be performed.

According to the second embodiment as described above, the error signal can be generated and the feedback control is facilitated, and therefore the positioning at the books can be fast performed. Therefore, a user-friendly optical information recording and reproducing device can be provided.

In the above-described embodiment, a case in which books are recorded with the reference light angles that are different by a half cycle or a quarter cycle in each page is described. However, the present invention is not limited thereto, and can be applied also to a case in which books are recorded with the reference light angles that are different by an n-th cycle (n: an integer).

### Third Embodiment

A third embodiment of the present invention will be described with reference to the accompanying drawings. A configuration of an optical information recording and reproducing device is the same as that of the first embodiment, and therefore descriptions will be omitted.

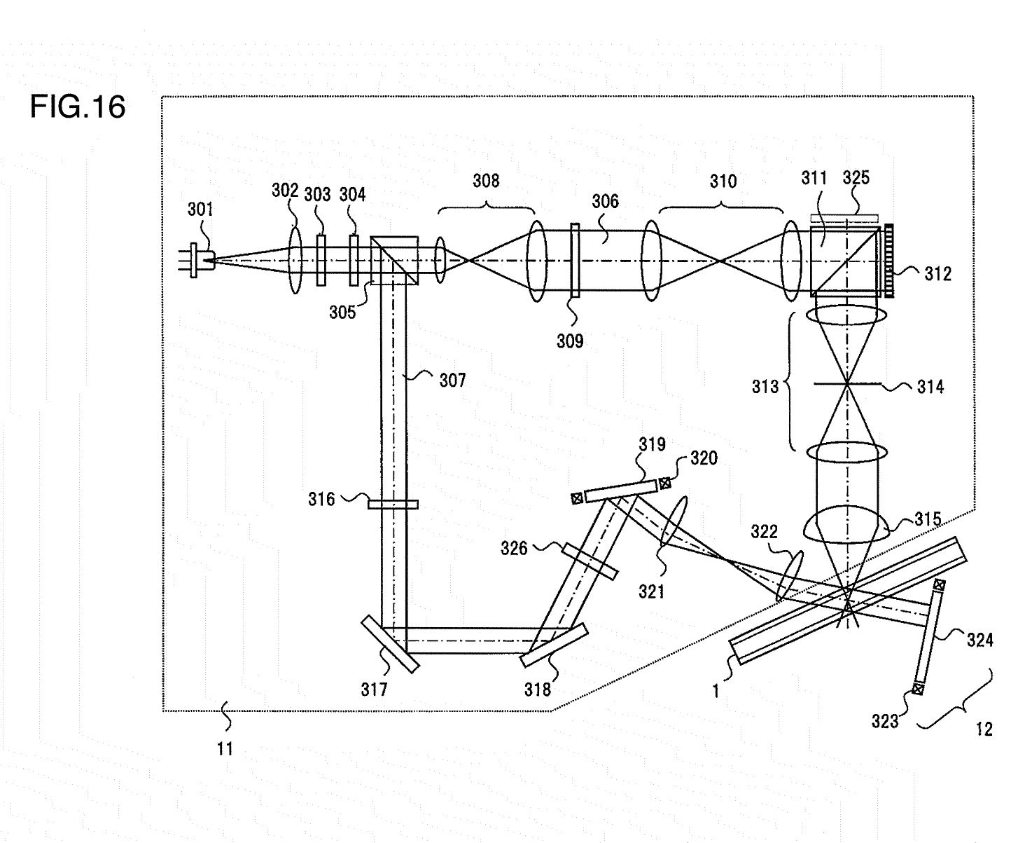

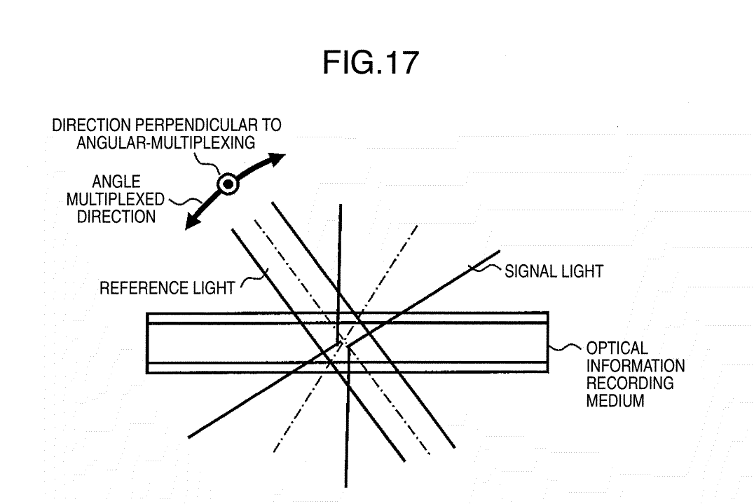

FIG. 16 illustrates an example of a fundamental optical system configuration of the pickup 11 in the optical information recording and reproducing device 10. A configuration is obtained by adding an angle control device 326 to the configuration of FIG. 3. The angle control device 326 is a device capable of controlling an angle in a direction perpendicular to an angle multiplexed direction to be controlled by a galvanometer mirror 319, and can be configured, for example, by liquid crystal elements. Note that control may be operated by using a galvanometer mirror, a deformable mirror, or the like, or the same mechanism may be made to be held in the reproduction reference light optical system 12. An angle to be controlled by the angle control device 326 is illustrated in FIG. 17. FIG. 17 illustrates an appearance in which the signal light and the reference light overlap each other in the optical information recording medium. Further, the reference light angles are controlled by the galvanometer mirror 319 in a plane that is composed of the reference light and the signal light, thereby performing angular-multiplexing. An angle in a direction perpendicular to this angle multiplexed direction is controlled by the angle control device 326.

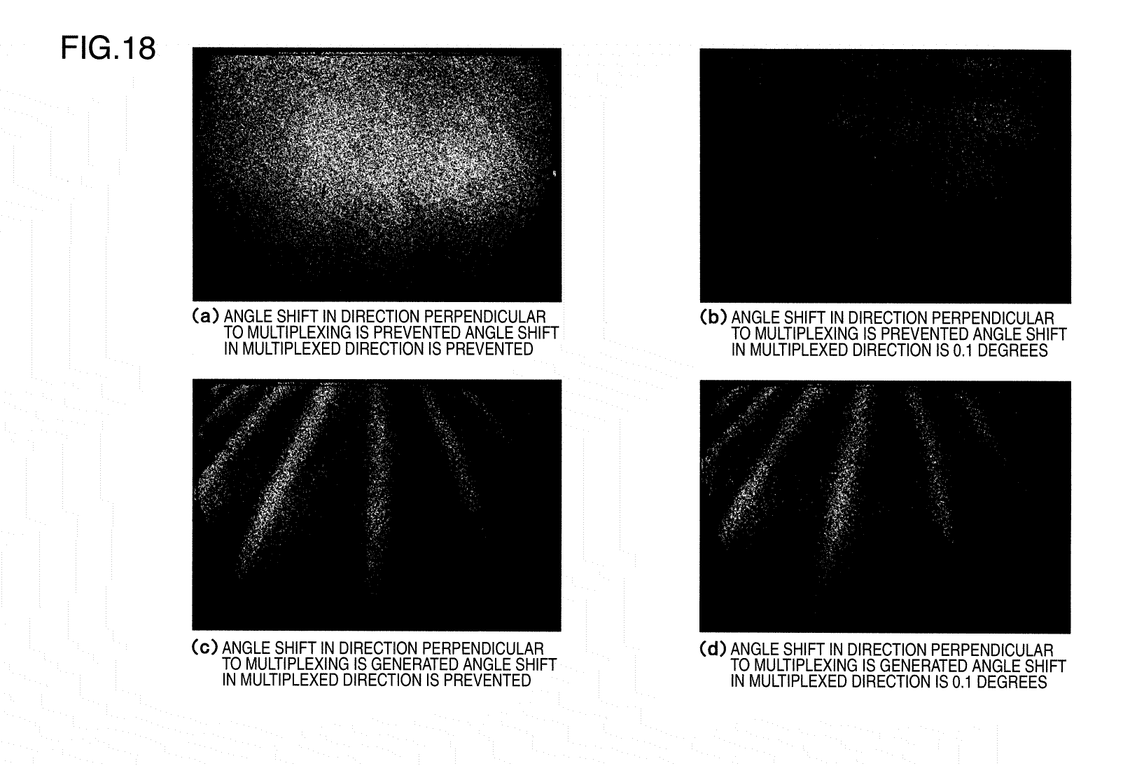

FIG. 18 is a view illustrating a relationship between a reproduced image and the presence or absence of a shift of the reference light angle in a direction perpendicular to multiplexing. FIG. 18 is reproduction results of the book in which angular multiplexing is recorded at a distance of 0.2 degrees.

FIG. 18A is an example of the reproduced image in the case in which an angle shift in a direction perpendicular to the multiplexing is prevented and an angle shift in the multiplexed direction is prevented. It is understood that the entire reproduced image becomes bright. FIG. 18B is an example of the reproduced image in the case in which an angle shift in a direction perpendicular to the multiplexing is prevented and an angle shift in the multiplexed direction is 0.1 degrees. It is understood that the entire reproduced image becomes dark.

FIG. 18C is an example of the reproduced image in the case in which an angle shift in a direction perpendicular to the multiplexing is generated and an angle shift in the multiplexed direction is prevented. It is understood that bright and dark stripes are generated in the reproduced image. A bright portion in the center of FIG. 18C is in the state in which only the center of the reproduced image is represented at the time when an angle shift in a direction perpendicular to the multiplexing is prevented and a part of adjacent pages are represented as adjacent bright portions. That is, a spread is considered to be made to be held in the reference light angle in the multiplexed direction, and at the same time, observed. FIG. 18D is an example of the reproduced image in the case in which an angle shift perpendicular to the multiplexed direction is generated and an angle shift in the multiplexed direction is 0.1 degrees.

It is understood that bright and dark stripes are generated in the reproduced image in the same manner as in FIG. 18C. Further, it is understood that bright portions of FIG. 18D are represented between the bright portions of FIG. 18C.

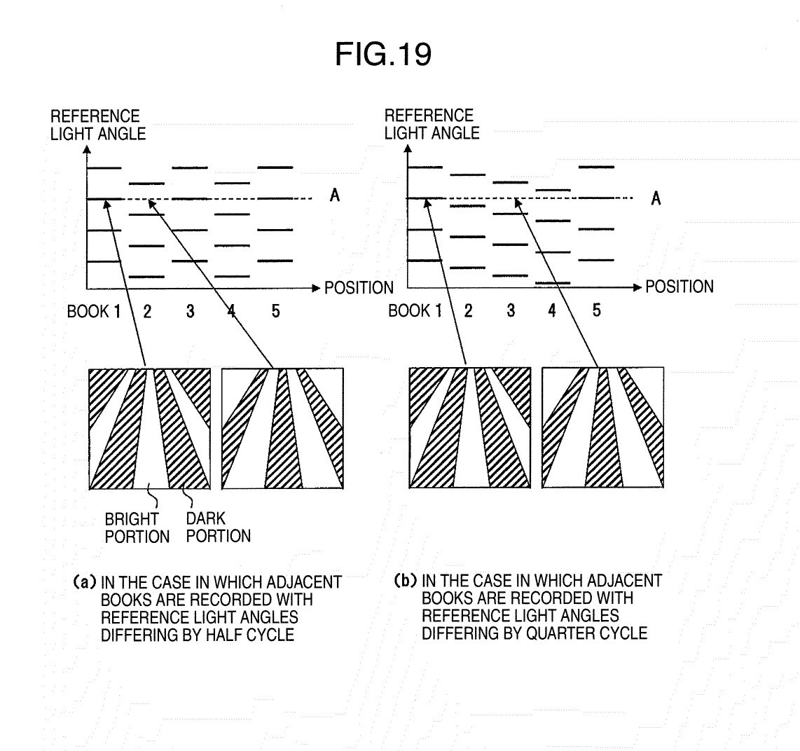

FIG. 19 is a view schematically illustrating a reference light recording angle of each book and the reproduced image during reproduction in the case in which an angle shift in a direction perpendicular to the multiplexing is generated.

In the same manner as in FIG. 1B, FIG. 19A is an example in the case in which the adjacent books are recorded with the reference light angles that are different by a half cycle in each page. An upper view of FIG. 19A illustrates a relationship between positions of the books and reference light angles with which the pages are recorded, and illustrates that the adjacent books are recorded with the reference light angles that are different by a half cycle in each page. Suppose that as illustrated in A of FIG. 19A, the reference light angle in the multiplexed direction is controlled to be matched to angles with which odd-numbered books are recorded, and further the angle is shifted to a direction perpendicular to the multiplexing to perform the reproduction. In this case, as illustrated in a lower view of FIG. 19A, bright portions are represented in the center of the reproduced images in the central position of the odd-numbered books, and dark portions are represented in the center of the reproduced images in the central position of the even-numbered books.

In the same manner as in FIG. 13, FIG. 19B is an example in the case in which the adjacent books are recorded with the reference light angles that are different by a quarter cycle in each page. An upper view of FIG. 19B is a view illustrating a relationship between positions of the books and the reference light angles with which the pages are recorded, and illustrates that the adjacent books are recorded with the reference light angles that are different by a quarter cycle in each page. Suppose that as illustrated in A of FIG. 19B, the reference light angle in the multiplexed direction is controlled to be matched to angles with which a first book and a fifth book are recorded in each page, and further the angles are shifted to a direction perpendicular to the multiplexing to perform the reproduction. In this case, as illustrated in the lower view of FIG. 19A, a bright portion is represented in the center of the reproduced image in the central position of the first book, and a dark portion is represented in the center of the reproduced image in the central position of the third book.

The reference light angle during recording is not necessarily matched to the reference light angle with which the reproduced image is obtained during reproduction. The above is one of causes that an angle in the recorded interference fringes on the hologram changes through an influence of a shrinkage in recording materials using post-cure after recording or an influence of a change in a temperature during recording and reproduction. Further, when a device for recording and a device for reproduction are different from each other, a shift may be generated in an angle due to a problem of the compatibility between devices. An appropriate reference light angle for reproduction is not understood in the stage of first accessing the book during reproduction, and therefore the target reference light angle is not assured. Therefore, there is the possibility that when the book is accessed by the method of the first embodiment or the second embodiment, the reference light angle is not appropriate and the intended reproduction light amount cannot be acquired.

In the case of performing recording and reproduction as illustrated in FIG. 19A, even if the appropriate reference light angle is not understood, areas for the bright portions and the dark portions are detected from the reproduced images and at least a part of the light amount of the areas for the bright portions and the dark portions in the reproduced images is detected, thereby accessing the book illustrated in the first embodiment. Further, in the case of performing recording and reproduction as illustrated in FIG. 19B, even if the appropriate reference light angle is not understood, areas for the bright portions and the dark portions are detected from the reproduced images and at least a part of the light amount of the areas for the bright portions and the dark portions in the reproduced images is detected to generate the error signal, thereby accessing the book illustrated in the second embodiment. Further, in this case, an operation for alternately switching the reference light angle required in the second embodiment is not required.

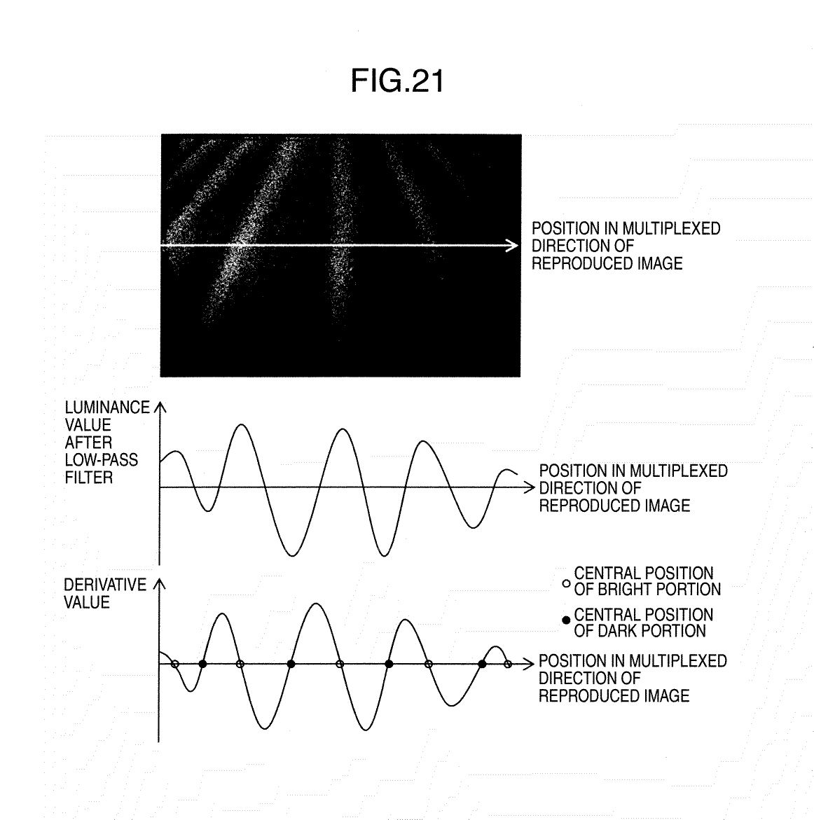

In FIG. 21, an example of a method for detecting the bright portions and the dark portions in the reproduced images is illustrated. First, bright and dark images are obtained by passing the reproduced image through a low-pass filter. Next, when a position in the multiplexed direction of the reproduced image is differentiated, the vicinity in which a derivative value is equal to zero can be detected as a central position of the bright portion or a central position of the dark portion. In FIG. 21, there is illustrated an example in which a central position of the bright portion is obtained at the time when the derivative value is equal to zero and a tilt is negative, and a central position of the dark portion is obtained at the time when the derivative value is equal to zero and a tilt is positive.

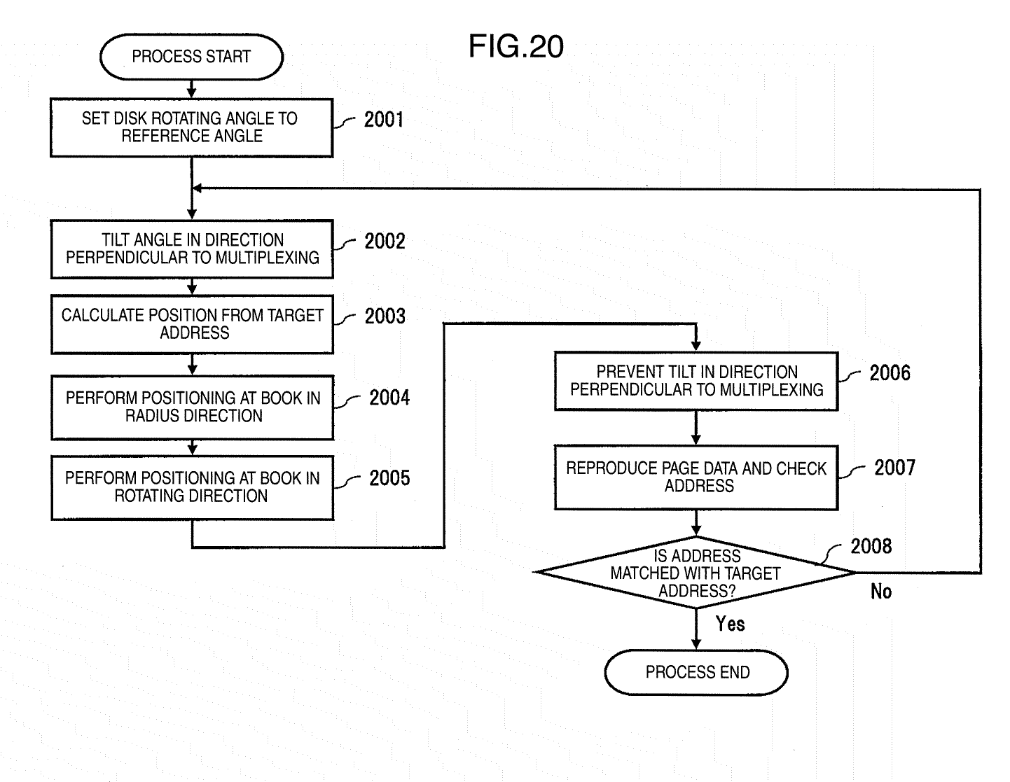

FIG. 20 is a view illustrating a flow for performing positioning at the target book.

First, the disk rotating motor control circuit 88 is controlled to drive the rotating motor 50, and is controlled to match a rotating angle of the optical information recording medium 1 to the reference angle (2001).

Next, an angle is tilted in a direction perpendicular to multiplexing of the reference light (2002), and the radius position and the rotating angle of the optical information recording medium of the target book are calculated from address information as a target (2003). On the basis of information about the calculated radius position, the access control circuit 81 is controlled to drive the pickup 11 to a radius direction of the optical information recording medium 1, and at the same time, is controlled to perform positioning at the book in the radius direction while the reference light is irradiated on the optical information recording medium 1 and the reproduction light amount is detected by the optical power detector 325 (2004). Next, on the basis of information about the rotating angle calculated at 2003, the disk rotating motor control circuit 88 is controlled to drive the rotating motor 50, and at the same time, is controlled to perform positioning at the book in a rotating direction while the reference light is irradiated on the optical information recording medium 1 and the reproduction light amount is detected by the optical power detector 325 (2005).

Next, a tilt in a direction perpendicular to the multiplexing is prevented (2006). Further, the page data is reproduced and the address is checked from header information and the like (2007). When positioning at the target book can be checked from the address information, access to the book is ended. When the positioning at the target book cannot be checked, the process returns to 2002 again and the positioning at the book is performed.

In the case in which signal quality of the page is deteriorated when the page data is reproduced at 2007, a fine adjustment of the book position may be carried out so that the signal quality becomes high.

For speeding up of the process, a detection area of the optical power detector 325 may be restricted and detected, and a fast optical power detector may be provided and used for detection of the light amount apart from the optical power detector 325.

According to the third embodiment as described above, even if the reference light angle appropriate for the reproduction is not understood, the reference light angle is shifted to a direction perpendicular to the multiplexing, and thereby positioning at the book can be performed. Therefore, a user-friendly optical information recording and reproducing device can be provided.

### Fourth Embodiment

A fourth embodiment of the present invention will be described with reference to the accompanying drawings. A configuration of an optical information recording and reproducing device is the same as that of the first embodiment, and therefore descriptions will be omitted.

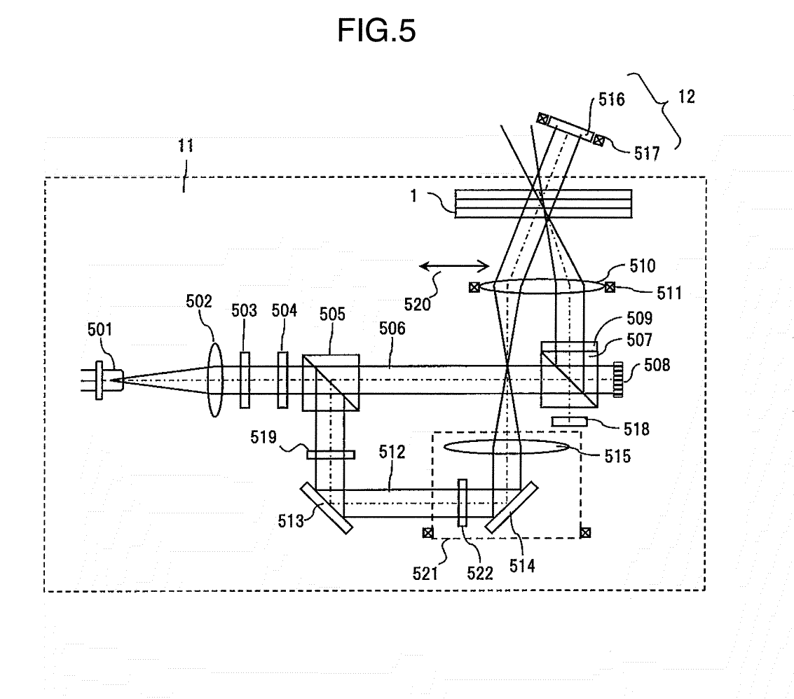

FIG. 5 is a view illustrating an example of a configuration of the pickup 11. In FIG. 5, a light beam emitted from a light source 501 is transmitted through a collimator lens 502 and is incident on a shutter 503. When the shutter 503 is open, the light beam is passed through the shutter 503. Then, a polarization direction is controlled so that a light volume ratio of p-polarization and s-polarization is a desired ratio through an optical device 504 composed of, for example, a ½ wavelength plate, etc., and then the light beam is incident on a polarization beam splitter 505.

The light beam that is transmitted through the polarization beam splitter 505 is incident on a spatial light modulator 508 via a polarization beam splitter 507. Signal light 506 to which information is added by the spatial light modulator 508 is reflected by the polarization beam splitter 507, and is propagated through an angle filter 509 through which only a light beam having a predetermined incident angle is passed. Thereafter, the signal light beam is collected on the optical information recording medium 1 by an objective lens 510.

On the other hand, the light beam reflected by the polarization beam splitter 505 serves as reference light 512, and is set to a predetermined polarization direction depending on the recording time or reproduction time by using a polarization direction conversion element 519. Then, the light beam is incident on a lens 515 via a mirror 513, an angle control device 522, and a mirror 514. The lens 515 plays a role in collecting the reference light 512 on a back focus plane of the objective lens 510. Further, the reference light that is once collected on the back focus plane of the objective lens 510 is incident as parallel light on the optical information recording medium 1 by the objective lens 510 again.

Here, the objective lens 510 and the optical block 521 can be driven, for example, to a direction illustrated in a reference numeral 520, and a position of the objective lens 510 or the optical block 521 is shifted along a driving direction 520. As a result, a relative position relationship between a collecting point in the objective lens 510 and that in the back focus plane of the objective lens 510 changes, and therefore the incident angle of the reference light that is incident on the optical information recording medium 1 can be set to a desired angle. In addition, in place of driving the objective lens 510 or the optical block 521, the incident angle of the reference light may be set to a desired angle by driving the mirror 514 by an actuator.

The angle control device 522 is a device capable of controlling an angle in a direction perpendicular to the driving direction 520, and can be configured, for example, by liquid crystal elements. Note that control may be operated by using a galvanometer mirror, a deformable mirror, or the like, or the same mechanism may be made to be held in the reproduction reference light optical system 12.

As described above, the signal light and the reference light are made incident on the optical information recording medium 1 so as to overlap each other. Thereby, interference fringe patterns are formed on the recording medium, and the patterns are written in the recording medium to thereby record information. Further, a position of the objective lens 510 or the optical block 521 is shifted along the driving direction 520, and thereby the incident angle of the reference light that is incident on the optical information recording medium 1 can be changed. Therefore, it is possible to perform recording using the angular-multiplexing.

In the case in which the recorded information is reproduced, the reference light is incident on the optical information recording medium 1 as described above and the light beam that is transmitted through the optical information recording medium 1 is reflected by a galvanometer mirror 516, thereby generating the reproduction reference light. The reproduction light reproduced by the reproduction reference light is propagated through the objective lens 510 and the angle filter 509. Thereafter, the reproduction light is transmitted through the polarization beam splitter 507 and is incident on an optical power detector 518, thereby reproducing recorded signals.

Even in the case of using an optical system in which the signal light and the reference light illustrated in FIG. 5 are made incident on the same objective lens, a method for performing positioning at any book illustrated in the first, second, and third embodiments can be also realized.

The fourth embodiment as described above has a configuration in which the signal light and the reference light are made incident on the same objective lens. As a result, the optical information recording and reproducing device having an advantage of being capable of largely miniaturizing the device can be provided as compared to the optical system configuration illustrated in FIG. 4.

### Fifth Embodiment

A fifth embodiment of the present invention will be described with reference to the accompanying drawings. A configuration of an optical information recording and reproducing device is the same as that of the first embodiment, and therefore descriptions will be omitted.

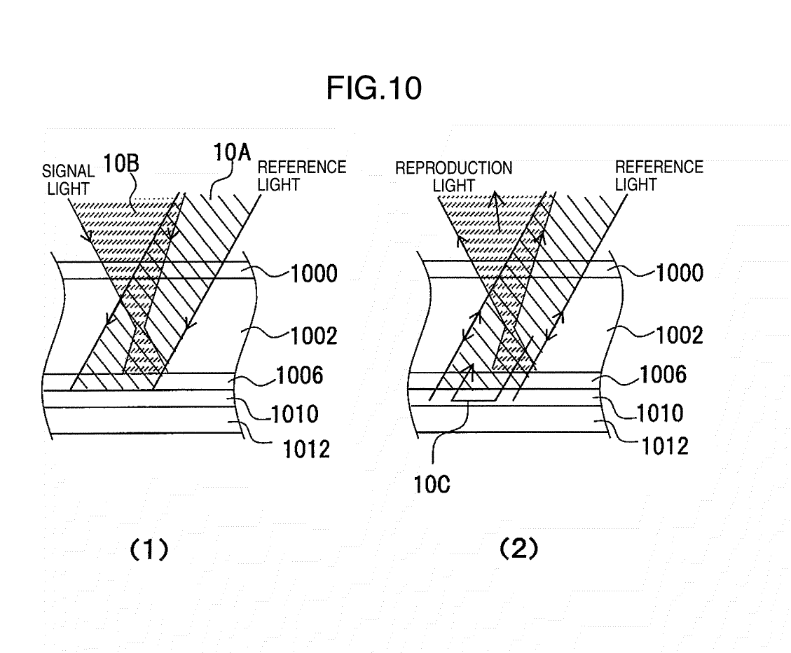

FIG. 10 is a view illustrating a layered structure of an optical information recording medium having a reflective layer. FIG. 10(1) illustrates a state in which information is recorded on the optical information recording medium, and FIG. 10(2) illustrates a state in which the information is reproduced from the optical information recording medium.

From the light pickup 11 side, the optical information recording medium 1 has a transparent cover layer 1000, a recording layer 1002, a light absorption/light transmission layer 1006, a light reflection layer 1010, and a third transparent protective layer 1012. An interference pattern of reference light 10A and signal light 10B is recorded on the recording layer 1002.

In the light absorption/light transmission layer 1006, solid state properties are converted so as to absorb the reference light 10A and the signal light 10B during recording of information, and transmit the reference light during reproduction of information. For example, by applying a voltage to the optical recording medium 1, a coloring state and a decoloring state in the light absorption/light transmission layer 1006 change. That is, during recording of information, the light absorption/light transmission layer 1006 turns out to be a coloring state and absorbs the reference light 10A and the signal light 10B that are passed through the recording layer 1002. During reproduction of information, the light absorption/light transmission layer 1006 turns out to be a decoloring state and transmits the reference light. The reference light 10A that is passed through the light absorption/light transmission layer 1006 is reflected by the light reflection layer 1010 to be changed into reproduction reference light 10C.

Further, WO3 as electrochromic (EC) materials can be used for the light absorption/light transmission layer 1006.

A voltage is applied to the materials, and thereby coloring or decoloring is generated in a reversible fashion. Further, during recording of information, the material is colored to absorb light, and during reproduction of information, the material is decolored to transmit light.

In the pickup illustrated in FIGS. 3 and 5, the reproduction reference light optical system is omitted to use the optical information recording medium illustrated in FIG. 10.

Even in the case of using the optical information recording medium illustrated in FIG. 10, a method for performing positioning at any book illustrated in the first, second, and third embodiments can be also realized.

According to the fifth embodiment as described above, the reproduction reference light is not required, and a compact optical information recording and reproducing device can be provided.

### Sixth Embodiment

A sixth embodiment of the present invention will be described with reference to the accompanying drawings. A configuration of an optical information recording and reproducing device is the same as that of the first embodiment, and therefore descriptions will be omitted.

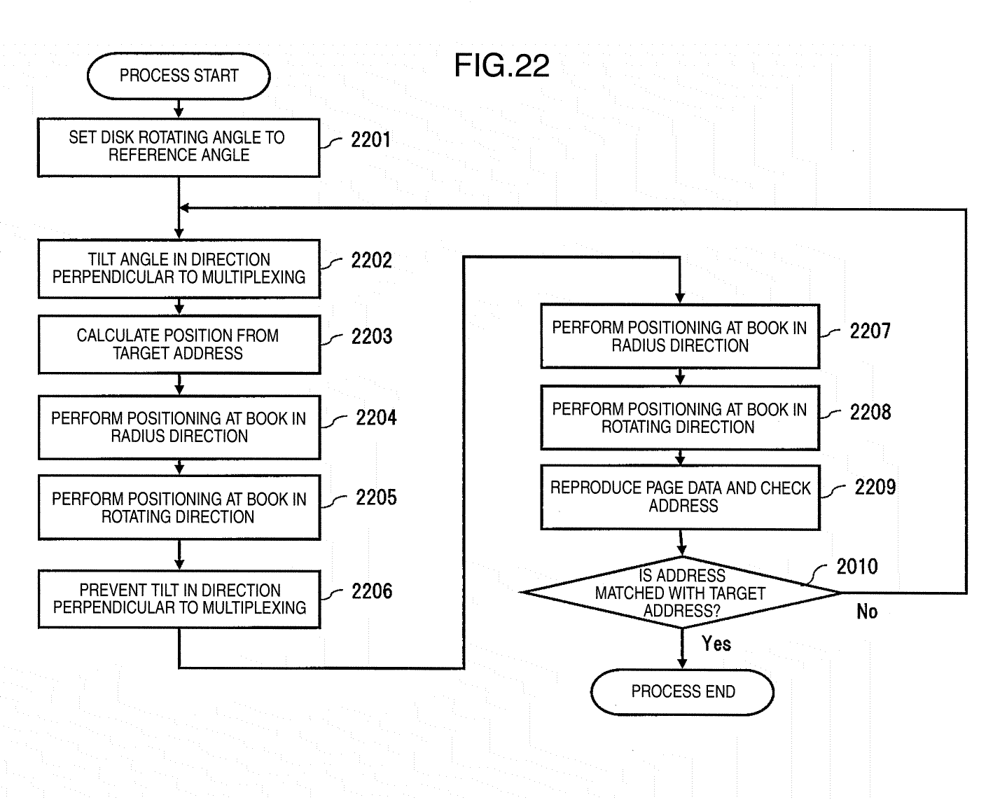

FIG. 22 is a view illustrating a flow for performing positioning at the target book.

First, the disk rotating motor control circuit 88 is controlled to drive the rotating motor 50, and is controlled to match a rotating angle of the optical information recording medium 1 to the reference angle (2201).

Next, an angle is tilted in a direction perpendicular to multiplexing of the reference light (2202), and the radius position and the rotating angle of the optical information recording medium of the target book are calculated from address information as a target (2203). On the basis of information about the calculated radius position, the access control circuit 81 is controlled to drive the pickup 11 to a radius direction of the optical information recording medium 1, and at the same time, is controlled to perform positioning at the book in the radius direction while the reference light is irradiated on the optical information recording medium 1 and the reproduction light amount is detected by the optical power detector 325 (2204). Next, on the basis of information about the rotating angle calculated at 2203, the disk rotating motor control circuit 88 is controlled to drive the rotating motor 50, and at the same time, is controlled to perform positioning at the book in a rotation direction while the reference light is irradiated on the optical information recording medium 1 and the reproduction light amount is detected by the optical power detector 325 (2205).

Next, a tilt in a direction perpendicular to the multiplexing is prevented (2206), and the access control circuit 81 is controlled to drive the pickup 11 to the radius direction of the optical information recording medium 1, and at the same time, is controlled to perform positioning at the book in the radius direction while the reference light is irradiated on the optical information recording medium 1 and the reproduction light amount is detected by the optical power detector 325 (2207). Next, the disk rotating motor control circuit 88 is controlled to drive the rotating motor 50, and at the same time, is controlled to perform positioning at the book in the rotation direction while the reference light is irradiated on the optical information recording medium 1 and the reproduction light amount is detected by the optical power detector 325 (2208).

Next, the page data is reproduced and the address is checked from header information and the like (2209). When positioning at the target book can be checked from the address information, access to the book is ended. When the positioning at the target book cannot be checked, the process returns to 2202 again and the positioning at the book is performed.

According to the sixth embodiment as described above, even if the reference light angle appropriate for the reproduction is not understood in the same manner as in the third embodiment, the reference light angle is shifted to a direction perpendicular to the multiplexing, and thereby the positioning at the book can be performed. In addition, thereafter, a shift of the reference light angle in a direction perpendicular to the multiplexing is prevented, and thereby the positioning at the book can be performed on the basis of the strong reproduction light amount as compared to a case in which the reference light angle is shifted to a direction perpendicular to the multiplexing. Therefore, high-precision positioning can be performed.

In addition, the present invention is not limited to the above-described embodiments, but includes various modifications. For example, the above-described embodiments are described in detail in order to clearly describe the present invention, and are not necessarily limited to the device having all the described constructions. Further, a part of constructions according to one embodiment can be replaced by those according to other embodiments, and the constructions according to other embodiments can be added to that according to one embodiment. Further, an addition, deletion, or replacement of the constructions according to other embodiments can be performed by using a part of the constructions according to each embodiment.

A part or all of the respective structures, functions, processing units, and processing approaches may be realized by hardware by designing through the integrated circuit, for example. Those structures, functions and the like may be realized by software by interpreting and executing the program for realizing the respective functions through a processor. Information with respect to the program, table, and file for realizing the respective functions may be stored in the recording unit such as the memory, hard disk, and SSD (Solid State Drive), or the recording medium such as the IC card, SD card, and DVD.

The examples show the control line and information line considered as necessary for the explanation, which does not necessarily show all the control lines and information lines of the product. Actually, almost all the components may be considered to be connected with one another.

### REFERENCE SIGNS LIST

1 Optical information recording medium
10 Optical information recording and reproducing device
11 Pickup
12 Reproduction reference light optical system
13 Disk Cure optical system
14 Disk rotating angle detecting optical system
81 Access control circuit
82 Light source drive circuit
83 Servo signal generation circuit
84 Servo control circuit
85 Signal processing circuit
86 Signal generation circuit
87 Shutter control circuit
88 Disk rotating motor control circuit
89 Controller
90 Input and output control circuit
91 External control device
301 Light source
303 Shutter
306 Signal light
307 Reference light
308 Beam expander
309 Phase mask
310 Relay lens
311 PBS prism
312 Spatial light modulator
313 Relay lens
314 Spatial filter
315 Objective lens
316 Polarization direction conversion element
320 Actuator
321 Lens
322 Lens
323 Actuator
324 Mirror
325 Optical power detector
326 Angle control device
501 Light source
502 Collimator lens
503 Shutter
504 Optical device
505 PBS prism
506 Signal light
507 PBS prism
508 Spatial light modulator
509 Angle filter
510 Objective lens
511 Objective lens actuator
512 Reference light
513 Mirror
514 Mirror
515 Lens
516 Galvanometer mirror
517 Actuator
518 Optical power detector
519 Polarization direction conversion element
520 Driving direction
521 Optical block

1. An optical information recording and reproducing device for recording an interference pattern of signal light and reference light as page data on an optical information recording medium through angular-multiplexing and reproducing information from the optical information recording medium, comprising:
a light source unit that emits light;
an optical splitting unit that splits the light into reference light and signal light;
an angle control unit that controls an angle in an angle multiplexed direction of the reference light that is incident on the optical information recording medium;
an optical detection unit that detects a reproduced image reproduced by the reference light; and
a position control unit that controls a position relationship between the reference light and the optical information recording medium, wherein
a set of page data is treated as a book, and during recording, at least a part of the page data in adjacent books is recorded while an incident angle in the angle multiplexed direction for the reference light is shifted by the angle control unit, and
during reproduction, at least a part of a light amount of a reproduced image is detected by the optical detection unit, and a position of the book is detected on a basis of information about the detected light amount.

2. The optical information recording and reproducing device according to claim 1, wherein
a shift of the incident angle in the angle multiplexed direction of the reference light during recording in adjacent books is approximately 1/n (n: an integer) of an angular distance of the page data.

3. The optical information recording and reproducing device according to claim 2, wherein
a shift of the incident angle in the angle multiplexed direction of the reference light during recording in adjacent books is approximately a half of an angular distance of the page data.

4. The optical information recording and reproducing device according to claim 2, wherein
a shift of the incident angle in the angle multiplexed direction of the reference light during recording in adjacent books is approximately a quarter of an angular distance of the page data.

5. The optical information recording and reproducing device according to claim 1, further comprising an angle control unit that controls the reference light that is incident on the optical information recording medium to a direction perpendicular to the angle multiplexed direction, wherein
during reproduction, the reference light that is incident on the optical information recording medium is reproduced so as to be tilted in a direction perpendicular to the angle multiplexed direction.

6. The optical information recording and reproducing device according to claim 3, wherein
a position of the book is detected on a basis of a maximum value or a minimum value of the light amount detected by the optical detection unit.

7. The optical information recording and reproducing device according to claim 4, wherein
a position of the book is detected on a basis of information according to a difference of the light amount detected by different books detected by the optical detection unit.

8. An optical information recording and reproducing method for use in an optical information recording and reproducing device for reproducing information from an optical information recording medium in which an interference pattern of signal light and reference light is recorded as page data through angular-multiplexing, comprising:
a recording step of treating a set of page data as a book and recording at least a part of the page data in adjacent books while an angle in an angle multiplexed direction of the reference light emitted to the optical information recording medium is shifted;
a light amount detecting step of detecting a light amount of reproduction light reproduced from the optical information recording medium; and
a position detecting step of detecting a position of the book on a basis of information about the detected light amount.

9. The optical information recording and reproducing method according to claim 8, wherein
in the recording step, adjacent books are recorded as page data with a shift amount of an angle in the angle multiplexed direction of the reference light emitted to the optical information recording medium being approximately 1/n (n: an integer).

10. The optical information recording and reproducing method according to claim 9, wherein
in the recording step, adjacent books are recorded as page data with a shift amount of an angle in the angle multiplexed direction of the reference light emitted to the optical information recording medium being approximately a half.

11. The optical information recording and reproducing method according to claim 9, wherein
in the recording step, adjacent books are recorded as page data with a shift amount of an angle in the angle multiplexed direction of the reference light emitted to the optical information recording medium being approximately a quarter.

12. The optical information recording and reproducing method according to claim 8, wherein
in the light amount detecting step, the reference light that is incident on the optical information recording medium is reproduced so as to be tilted in a direction perpendicular to the angle multiplexed direction.

13. The optical information recording and reproducing method according to claim 10, wherein
a position of the book is detected on a basis of a maximum value or a minimum value of the light amount detected in the light amount detecting step.

14. The optical information recording and reproducing method according to claim 11, wherein
a position of the book is detected on a basis of information according to a difference of the light amount detected by different books detected in the light amount detecting step.

15. An optical information reproducing device for reproducing information from an optical information recording medium in which an interference pattern of signal light and reference light is recorded as page data through angular-multiplexing, comprising:
a light source unit that emits light;
a reference light generation unit that generates reference light from the light;
an angle control unit that controls an angle in an angle multiplexed direction of the reference light that is incident on the optical information recording medium;
an optical detection unit that detects a reproduced image reproduced by the reference light; and
a position control unit that controls a position relationship between the reference light and the optical information recording medium, wherein
in the optical information recording medium, at least a part of the page data in adjacent books is recorded as information while an incident angle in the angle multiplexed direction of the reference light is shifted by the angle control unit, and
at least a part of a light amount of a reproduced image is detected by the optical detection unit, and a position of the book is detected on a basis of information about the detected light amount.

16. The optical information reproducing device according to claim 15, wherein
a shift of the incident angle in the angle multiplexed direction of the reference light during recording in adjacent books is 1/n (n: an integer) of an angular distance of the page data.

17. The optical information reproducing device according to claim 16, wherein
a shift of the incident angle in the angle multiplexed direction of the reference light during recording in adjacent books is approximately a half of an angular distance of the page data.

18. The optical information reproducing device according to claim 16, wherein
a shift of the incident angle in the angle multiplexed direction of the reference light during recording in adjacent books is approximately a quarter of an angular distance of the page data.
